(19) United States
(12) Patent Application Publication
(10) Pub. No.: US 2025/0016194 A1
(43) Pub. Date: Jan. 9, 2025

(54) DISTRIBUTED DENIAL OF SERVICE PROTECTION MANAGEMENT

(71) Applicant: Salesforce, Inc., San Francisco, CA (US)

(72) Inventors: Jose Lefin P J, Bangalore (IN); Prabhat Singh, San Francisco, CA (US); Ramanjaneyulu Y. Talla, Bangalore (IN); Premenjit Das, Bangalore (IN)

(21) Appl. No.: 18/891,779

(22) Filed: Sep. 20, 2024

Related U.S. Application Data
(63) Continuation-in-part of application No. 18/162,436, filed on Jan. 31, 2023.

(51) Int. Cl. H04L 9/40

(52) U.S. Cl. CPC H04L 63/1458; H04L 63/0263; H04L 63/1425

(57) ABSTRACT

Methods and systems for distributed denial of service (DDoS) protection management are described. The system may aggregate, from a web application firewall (WAF) bridge service that interfaces with one or more WAF services, one or more DDoS event records associated with one or more DDoS events. The system may analyze the one or more DDoS event records via an analysis of one or more headers and one or more payloads of the one or more DDoS event records, logging information, and a threat intelligence feed. The system may generate a security configuration that indicates one or more parameters of the one or more WAF services to be set. The system may validate the security configuration and may transmit the security configuration to the one or more WAF services based at least in part on the validation.

### CROSS-REFERENCE TO RELATED APPLICATIONS

This application is a continuation-in-part of U.S. patent application Ser. No. 18/162,436 by P J et al., entitled “TECHNIQUES FOR PROCESSING QUERIES RELATED TO NETWORK SECURITY” and filed Jan. 31, 2023, which is assigned to the assignee hereof and incorporated herein by reference in its entirety.

### FIELD OF TECHNOLOGY

The present disclosure relates generally to database systems and data processing, and more specifically to techniques for distributed denial of service (DDoS) protection management.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.). The cloud platform can be spread over multiple substrates also.

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud computing systems, administrative users or end customers, may manage network security operations. However, such operations may be improved.

### BRIEF DESCRIPTION OF THE DRAWINGS

FIGS. 1 and 2 illustrate examples of computing environments that support techniques for processing queries related to network security in accordance with aspects of the present disclosure.

FIG. 3 illustrates an example of a messaging interface that supports techniques for processing queries related to network security in accordance with aspects of the present disclosure.

FIG. 4 illustrates an example of a dashboard interface that supports techniques for processing queries related to network security in accordance with aspects of the present disclosure.

FIGS. 5 and 6 illustrate examples of process flows that support techniques for processing queries related to network security in accordance with aspects of the present disclosure.

FIG. 7 illustrates a block diagram of an apparatus that supports techniques for processing queries related to network security in accordance with aspects of the present disclosure.

FIG. 8 illustrates a block diagram of a query processing component that supports techniques for processing queries related to network security in accordance with aspects of the present disclosure.

FIG. 9 illustrates a diagram of a system including a device that supports techniques for processing queries related to network security in accordance with aspects of the present disclosure.

FIGS. 10 and 11 illustrate flowcharts showing methods that support techniques for processing queries related to network security in accordance with aspects of the present disclosure.

FIG. 12 shows an example of a system that supports distributed denial of service protection management in accordance with aspects of the present disclosure.

FIG. 13 shows an example of a process flow that supports distributed denial of service protection management in accordance with aspects of the present disclosure.

FIG. 14 shows a block diagram of an apparatus that supports distributed denial of service protection management in accordance with aspects of the present disclosure.

FIG. 15 shows a block diagram of a security manager that supports distributed denial of service protection management in accordance with aspects of the present disclosure.

FIG. 16 shows a diagram of a system including a device that supports distributed denial of service protection management in accordance with aspects of the present disclosure.

FIG. 17 shows a flowchart illustrating methods that support distributed denial of service protection management in accordance with aspects of the present disclosure.

### DETAILED DESCRIPTION

A cloud computing system may employ a variety of services to configure, maintain, and update the security posture of the cloud computing system. These services may perform security-related tasks such as, for example, verifying that a given internet protocol (IP) packet is from an authorized IP address, connecting new IP addresses to an existing network security service, creating/enforcing tenant-specific network security policies, debugging network connection issues, checking and configuring network settings, etc. Some of these services may be implemented using a multi-substrate cloud architecture. As described herein, a substrate may refer to the infrastructure underlying a particular service instance, such as a public cloud infrastructure or a physical data center infrastructure managed by an organization. A substrate may be defined by (i.e., composed of) elements such as a data center, network, system architecture, storage component, rack provisioning, hardware configuration, or the like. A substrate forms the base layer on which all higher-layer products and services in an organization can operate.

In some cases, users of a cloud computing system may have network security-related queries or requests. For example, a user may want to adjust approval settings for a particular service or determine whether a given service is reachable from a corporate network. In some cloud computing systems, such queries are directed to another user, such as a network security engineer or a system administrator. Manually resolving such queries may be prohibitively time-consuming for larger systems in which hundreds or thousands of queries are generated each day. Furthermore, relying on other users to handle network security-related issues may introduce unacceptable delays, errors, and system vulnerabilities.

The techniques described herein provide for using a query management service (referred to herein as Sage) to autonomously process network security-related queries from users of a cloud computing environment, which may be spread across multiple substrates. The query management service may be integrated with various third-party tools and services such that the query management service can automatically perform various network-security related actions (for example, retrieving connectivity status information or creating a new policy for a service instance) without manual intervention. In accordance with the techniques described herein, an end user (such as a client or administrator of the cloud computing environment) may enter a network security-related query via a user interface of a communication service (such as a third-party messaging application).

After receiving the query from the communication service, the query management service may use a third-party natural language processing (NLP) model or a generative artificial intelligence (AI) model to analyze the query and determine the intent of the query. For example, the NLP model may determine that the end user (from which the query originated) is attempting to execute a pipeline run, get a pull request approved, open/close a work item, etc. Once the intent is determined, the query management service may execute various pre-configured actions to retrieve information, update policies, diagnose network issues, manage configurations etc. Thereafter, the query management service may return query results to the user via the communication service. For example, the query management service may post or otherwise display an indication of requested policy details, error log information, diagnostic results, or the like.

Further, in some examples, the prevalence of web applications operating at the Layer 7 (L7) layer exposes them to heightened risks of distributed denial of service (DDoS) attacks. L7 DDoS attacks aim to disrupt web applications by inundating network or server resources with a barrage of hypertext transfer protocol (HTTP) traffic, targeted application programming interface (API) calls, or other communications. Managing such attacks, particularly in expansive large scale multi-substrate deployments featuring diverse vendor-specific L7 DDoS protection solutions, presents significant challenges. Coordination of mitigation efforts, configuration management, signature updates, incident response, alert handling, analysis, and query resolution demand sophisticated automation to timely and effectively protect against evolving threats. However, some approaches may be improved.

The subject matter described herein further discloses systems and methods for an automated bot system designed to address the complexities of managing L7 DDoS attacks within large-scale, multi-substrate deployments. With a focus on enhancing network security and resilience, the subject matter described herein includes handling, mitigation, incident response, and query resolution processes associated with L7 DDoS attack protection and management. For example, the techniques described herein may manage existing L7 DDoS protection technologies such as Web Application Firewalls (WAFs) using custom configurations that may be generated based on an analysis of headers and bodies of DDoS event data (or records thereof), an analysis of logging information received from the WAFs, an analysis of one or more threat intelligence feeds, or any combination thereof. This configuration may be validated or “sandboxed” before being deployed to the WAFs. In at least these ways, a system may streamline and improve the handling, mitigation, incident response, and query resolution processes associated with DDoS protection and management. Such a system may enhance the efficiency, scalability, and effectiveness of L7 DDoS protection, thereby fortifying network security and ensuring uninterrupted availability of web applications. Further, a system implementing the techniques described herein may reduce operational overhead, improve response times and resource utilization, enabling more effective and efficient. As such a system may be designed to scale across diverse substrates and third-party WAF solutions, the system accommodates evolving infrastructure considerations and supports seamless integration with existing security and network architectures. In some examples, the system employs techniques to study existing attack pattern combinations, continuously analyze current attack patterns and dynamically adjust mitigation strategies in real-time. By adapting to such evolving attack vectors and traffic patterns, the system enhances the efficacy of DDoS mitigation efforts, providing a resilient defense mechanism against emerging threats. Further, the reverse attack data flow techniques aid in placing loads on attackers, eventually helping to stop the DDoS from the attacker side. In some examples, the system may leverage contextual information such as application behavior, user interactions, and threat intelligence feeds and may further performs sophisticated risk assessments to prioritize mitigation actions and allocate resources effectively. By contextualizing threat severity (e.g., based on potential impact and operational dependencies), the system improves resource allocation and reduces the likelihood of false positives, enhancing overall security posture. In some examples, the system may (e.g., through predictive analytics and anomaly detection techniques), anticipate potential DDoS incidents before they occur, enabling proactive mitigation measures to be implemented preemptively.

Aspects of the present disclosure may be implemented to realize one or more of the following advantages. The query management service described herein may automatically interpret and process network security related-queries (which may be related to multiple substrate components) from users of a communication service, thereby reducing the quantity of network security-related queries that are manually resolved by system administrators or network security engineers. Furthermore, using a query management service to autonomously handle requests related to network security may enable end users to obtain query results, analyze, troubleshoot connectivity issues, or submit service requests in real-time (i.e., without waiting for another user to manually resolve each query). The query management service described herein may also customize query results according to feedback provided by end users, resulting in higher user satisfaction and improved user experience.

Further, by forecasting attack trends, identifying vulnerable assets, and recommending proactive security measures, the system stays ahead of emerging threats and mitigate risks proactively, reducing the likelihood of service disruptions and data breaches. In some examples, the system orchestrates coordination and communication among disparate security tools, network devices, and incident response teams, automating incident triage, escalation, and resolution workflows. By centralizing incident management processes and facilitating cross-functional collaboration, the system reduces mean time to detect (MTTD) and mean time to respond (MTTR), enabling organizations to minimize downtime, mitigate financial losses, and preserve customer trust in the face of L7 DDoS attacks.

Aspects of the present disclosure are initially described in the context of computing environments, messaging interfaces, dashboard interfaces, systems, and process flows. Aspects of the present disclosure are further illustrated by and described with reference to apparatus diagrams, system diagrams, and flowcharts that support techniques for processing queries related to network security.

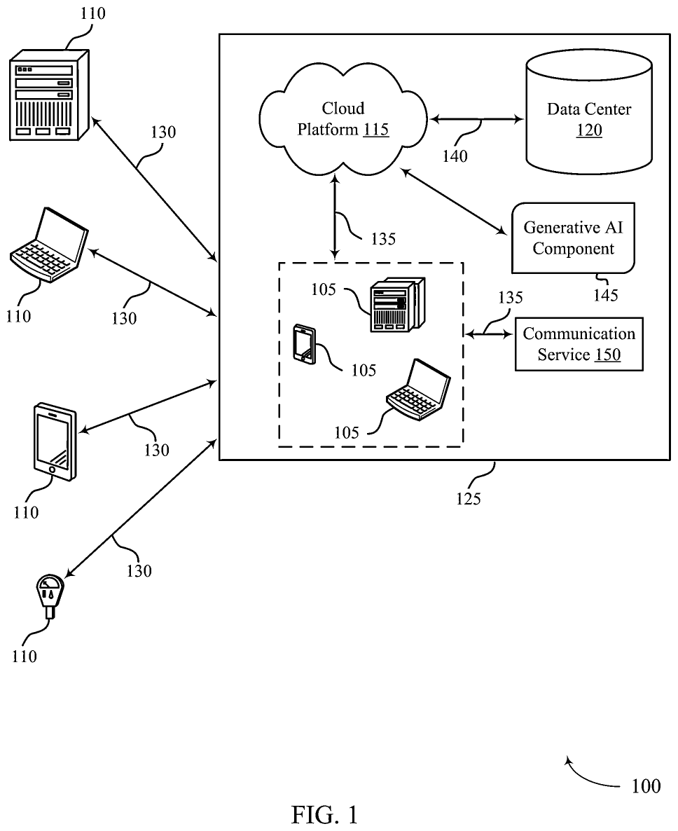

FIG. 1 illustrates an example of a computing environment 100 that supports techniques for processing queries related to network security in accordance with various aspects of the present disclosure. The computing environment 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server, a smartphone, or a laptop. In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction 130. The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server, a laptop, a smartphone, or a sensor. In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

The cloud platform 115 may include cloud clients 105, servers, and data center 120. In some cases, data processing may occur at any of the components of the cloud platform 115, or at a combination of these components. In some cases, servers may perform the data processing. The servers may be a cloud client 105 or located at data center 120.

The computing environment 100 may be an example of a multi-tenant system. For example, the computing environment 100 may store data and provide applications, solutions, or any other functionality for multiple tenants concurrently. A tenant may be an example of a group of users (e.g., an organization) associated with a same tenant identifier (ID) who share access, privileges, or both for the computing environment 100. The computing environment 100 may effectively separate data and processes for a first tenant from data and processes for other tenants using a system architecture, logic, or both that support secure multi-tenancy. In some examples, the computing environment 100 may include or be an example of a multi-tenant database system.

A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the computing environment 100 may run a single instance of software on a processing device (e.g., a server, server cluster, virtual machine) to serve multiple tenants. Such a multi-tenant system may provide for efficient integrations (e.g., using APIs) by applying the integrations to the same software application and underlying architectures supporting multiple tenants. In some cases, processing resources, memory resources, or both may be shared by multiple tenants.

As described herein, the computing environment 100 may support any configuration for providing multi-tenant functionality. For example, the computing environment 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The computing environment 100 may support scaling of tenants within the multi-tenant system, for example, using scale triggers, automatic scaling procedures, scaling requests, or any combination thereof. In some cases, the computing environment 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the computing environment 100 may support the use of a large language model (generative AI model), such as the generative AI component 145. In some examples, a generative AI component 145 may also be referred to as any of an artificial intelligence (AI), a generative AI (GAI), a GAI model, a large language model (LLM). The generative Al component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The computing environment 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In accordance with aspects of the present disclosure, a query management service supported by the cloud platform 115 may receive an indication of a query from a user of a communication service 150 via a public proxy between the query management service and the communication service 150. The query management service may determine an intent of the query based on using a third-party NLP model to analyze the query received from the communication service 150. The query management service may obtain query results by executing, within the computing environment 100, a sequence of actions that correspond to the intent of the query. The query management service may transmit an indication of the query results to the communication service 150 via the public proxy, where the query results are rendered according to feedback information provided by the user.

The computing environment 100 may be an example of a multi-substrate computing system. As described herein, a substrate is an underlying infrastructure, such as a public cloud infrastructure like Amazon Web Services (AWS), Google Cloud Platform (GCP), Microsoft Azure, AliCloud, etc. A substrate may also refer to a physical data center infrastructure managed by an organization. A substrate is composed of a data center, network, storage, rack provisioning, architecture, and hardware engineering disciplines. A substrate forms the base layer for all the products in organization to operate and innovate on.

In examples, the cloud platform 115 may manage one or more operations of WAFs operating in association with the cloud platform 115 to protect the cloud platform 115 from DDoS or other cyber attacks. The cloud platform 115 may obtain one or more records of DDoS events (e.g., current or past events) and may convert the records into a common format (e.g., through the use of generative AI models). The cloud platform 115 may analyze the DDoS records (e.g., by analyzing the headers and bodies, logging information, and threat intelligence feed information) to determine one or more parameters to set in one or more configurations that are to be applied to the WAFs. The configurations may be validated and pushed to the WAFs by the cloud platform 115 for deployment. In some examples, the cloud platform 115 may also manage queries and configuration instructions received from a cloud client 105. For example, a cloud client 105 may query the cloud platform 115 for information associated with the DDoS attacks, the configuration(s) pushed to the WAFs, or one or more other aspects of the DDoS management and protection operations described herein. The cloud platform 115 may respond with one or more responses generated using the generative AI component 145. For example, the generative AI component 145 may interpret the query, indicate one or more actions to be performed (e.g., information retrieval, such as statistics, configuration information, or any other information associated with the cloud platform 115) and may proved the cloud platform 115 with a response that is to be provided to the cloud client 105.

Existing approaches to DDoS protection may suffer from inadequate performance due to misconfiguration or incorrect analysis of information. Additionally, or alternatively, some approaches may have difficulty managing multiple WAF services (e.g., from multiple vendors), particularly in large-scale systems that are to defend against large-scale attacks, where simply providing many different configurations or settings to anticipate all possible attacks is not reasonable, not feasible, or not possible, as demands on protection solutions to store such large amounts of data and perform such extensive analysis (e.g., detecting many such patterns during attacks) is problematic. Additionally, or alternatively, some approaches may provide little to no transparency or illumination into the operation of the DDoS protection systems.

The techniques described herein reduce or eliminate such challenges. For example, a system may automatically analyze DDoS events to obtain improved information about the DDoS events and attacks to better protect the system. The configurations may be generated dynamically to adjust to different characteristics of different DDoS attacks that the system may face. Further, such configurations may account for additional characteristics that other approaches may miss and may provide such details to multiple WAFs in the appropriate formats for such multiple WAFs. Further, a system may employ the use of generative AI to respond to customer or administrator queries about the DDoS protection, thereby allowing increased transparency and facilitating better and faster decision-making before, during, and after DDoS attack situations.

For example, a user or administrator may configure a system to automatically analyze and respond to DDoS attacks by managing multiple WAFs as described herein. The user may configure the system via a web interface or through a chat interface backed by one or more generative AI models. The system may use the initial configuration to set up the automatic detection, analysis, and provisioning of DDoS protection configurations that may be provided to the WAFs. If desired, a user or administrator may transmit a query to the system about the DDoS protection, and the system may respond to the user or administrator (e.g., through the use of a generative AI model). The system may further perform one or more actions based on the user or administrator query to manage the operation of the DDoS protection techniques as described herein.

It should be appreciated by a person skilled in the art that one or more aspects of the disclosure may be implemented in a computing environment 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

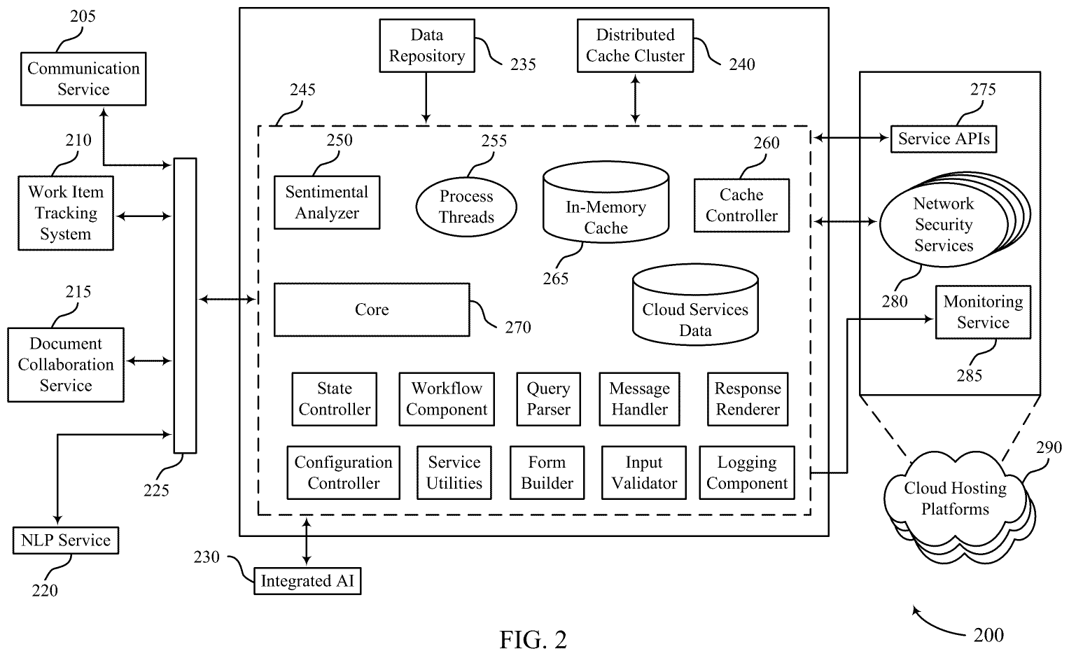

FIG. 2 illustrates an example of a computing environment 200 that supports techniques for processing queries related to network security in accordance with aspects of the present disclosure. The computing environment 200 may implement or be implemented by aspects of the computing environment 100. For example, the computing environment 200 includes a query management service 245, which may be supported by one or more components of the cloud platform 115 described with reference to FIG. 1. The computing environment 200 also includes a communication service 205, which may be an example of the communication service 150 described with reference to FIG. 1. The computing environment 200 may be an example of a distributed (i.e., multi-cloud) computing system that supports automatic query resolution for queries applicable to multiple substrates.

In the example of FIG. 2, the query management service 245 (also referred to as Sage or Sage bot/service) may receive and parse message events, evaluate the intent of the messaging events, and perform corresponding actions (for example, making calls to service APIs 275, network security services 280, and other third-party services managed by cloud hosting platforms 290). The query management service 245 may resolve network security-related queries in a fully automated manner, format query responses to enhance user experience, and provide customized results for display in the communication service 205.

The data repository 235 (equivalently referred to herein as Vault Service) may store credentials that the query management service 245 uses to access different APIs. The monitoring/logging service 285 may store metrics and logs published from different sources like Spinnaker, internal services, etc. The monitoring/logging service 285 may have metrics for network security service pipeline runs that can be used to answer queries and automated debugging. The monitoring/logging service 285 may be integrated with other services (i.e., Argus) and provide alerts for different sets of metrics. The monitoring/logging service 285 may provide on-demand alerts to service owners based on network security service queries.

The query management service 245 may use a public proxy 225 to communicate with third-party services and applications, such as the communication service 205 (i.e., Slack), a work item tracking system 210, a document collaboration service 215, and an NLP service 220, among other examples. All internet requests may go through the public proxy 225. For services and applications outside the system (such as the NLP service 220 and the communication service 205), requests may go through the public proxy 225.

The NLP service 220 may be an example of a third-party NLP service that provides conversational artificial intelligence (AI) capabilities. The NLP service 220 can extract intent from message events received by the query management service 245. Any third-party NLP service (such as Amazon Lex) can be used to perform this NLP analysis.

Internally, the query management service 245 may function as a single process with 3 threads. One of the process threads 255 does periodic data and configuration sync-ups, one of the process threads 255 does network security posture data sync-ups, and one of the process threads 255 is dedicated for handling customized cache operations (e.g., eviction). In some implementations, the query management service 245 may use customized eviction and cache cleaning mechanisms that offer improved performance over standard methods where the least recently used objects are evicted. To speed up operations in the communication service 205 (e.g., Slack), a cache controller 260 can maintain an in-memory cache 265. If a deployment is done on multiple pods, the in-memory cache 265 may be synched to a distributed cache cluster 240 (i.e., a Redis cluster or any suitable third-party distributed cache) such that all instances have similar cache data.

The core component 270 of the query management service 245 leverages multiple sub-components (such as a state controller, a workflow component, a query parser, a message handler, a response handler, a configuration controller, a service utilities component, a form builder, an input validator, and a logging component) to interpret and process queries from the communication service 205. The sentimental analyzer 250 may be configured to perform a sentimental analysis of end users (i.e., customers) based on historic feedback information, which helps improve the pertinence of subsequent responses.

The communication service 205 may support a variety of APIs, such as Event/Socket Mode APIs and real-time messaging (RTM) APIs. These APIs and programming paradigms can be used to resolve issues on the communication service 205. The automated query resolution techniques described herein may leverage bidirectional communication and Socket Mode Event API(s) to handle queries related to network security.

The query management service 245 can be deployed either as a standalone application or as a service within a Kubernetes cluster in any of the substrates. The service language/framework used for the query management service 245 may employ a generic object-oriented design such that third-party applications and services can be easily integrated with the query management service 245, which can be generalized for any number of use cases. In some implementations, the query management service 245 may resolve primary queries in a recursive manner, for example, by communicating with an integrated AI 230 (e.g., an external application or Slack bot) for dependent queries.

The computing environment 200 may support various software development kits (SDKs) such as Python, Node, and Java. Additionally, there are community-developed libraries that provide similar assistance for languages like C #, Go, .NET, and others. In some implementations, it may be preferable to use an official SDK supported by the computing environment 200. In one example, the query management service 245 may be written in Python.

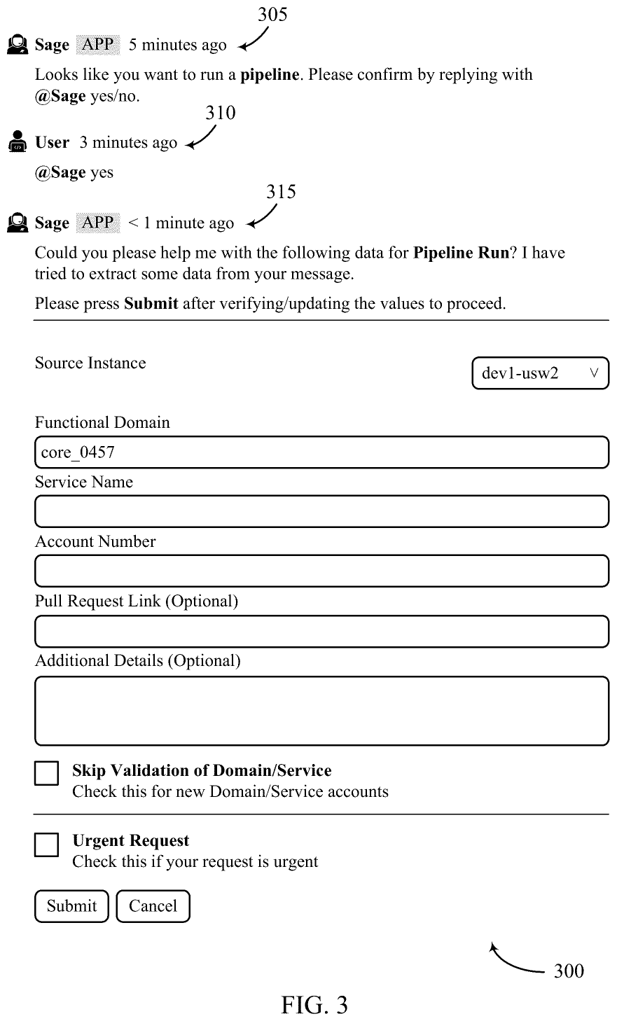

FIG. 3 illustrates an example of a messaging interface 300 that supports techniques for processing queries related to network security in accordance with aspects of the present disclosure. The messaging interface 300 may implement or be implemented by aspects of the computing environment 100 or the computing environment 200. For example, the messaging interface 300 may be displayed to a user of the communication service 150 and/or the communication service 205, as described with reference to FIGS. 1 and 2. The messaging interface 300 may illustrate an example of a workflow-based interaction, where a query management service (such as the query management service 245 described with reference to FIG. 2) provides an end user with customized (and, in some cases, pre-populated) user interface forms.

As described herein with reference to FIGS. 1 and 2, a network security team may receive a large number of queries and questions from service owners who want to know the state of their network security posture (which may be spread across multiple substrates). Service owners may also request assistance with defining security policies and/or troubleshooting issues across multiple substrates, network security services, etc. Many of these queries can be retrieved from the system state and intelligent co-relations. As the rate of deployment increases at the multi-cloud level, the manual effort to handle these queries may increase proportionately.

The automated query resolution mechanisms disclosed herein may support automatic triaging of network security-related issues spread across multiple substrates, network security services, etc. This may help network security teams provide better service for network security products, and may provide more visibility into existing network configurations, policy deployments, security states, mitigations, etc. The query management service described herein may also be referred to as Sage. The Sage service may be an example of a Slack bot that helps with multiple network security solutions spread across multiple cloud substrates and related queries in public Slack support channels. The Sage bot may provide improved user experience and NLP-based message handling to solve operations-related queries in a fully automated manner.

Sage may provide end users with the capability to perform operations like getting a pull request approved for a change review, implementing a pipeline run, handling a connectivity query, performing an error check, checking the status of a pipeline run, getting help information, suggesting security groups, debugging connection failures, fixing spinnaker errors, fixing network security-related errors, handling public proxy errors, getting manual help, answering general questions related to network security services, getting statistics of network security services, and getting random jokes.

When organizations onboard services to a multi-substrate cloud environment (referred to herein as Falcon), the organizations may implement changes in configuration files located in a distributed version control system, such as Git. After all changes are made and merged, Falcon Instance Repeatable Environment (FIRE) Bill of Materials (BOM) hydration takes place, which involves collecting all data needed for Falcon realization. FIRE BOM hydration creates relevant multi-substrate cloud accounts and adds metadata for each cloud-formed data center/service. Each cloud-formed data center may have a corresponding FIRE BOM. After the FIRE BOM is hydrated, a network security solution service may create terraform artifacts to apply a specific policy. This network security solution service runs periodically (i.e., every 30 minutes), and utilizes information from other repositories associated with different cloud-formed data centers. The periodic run time can be configured by administrators.

The terraform plan may be executed by another pipeline that runs periodically (i.e., every 24 hours) and applies specific policies in multi-substrate cloud data centers. The periodic run time of this pipeline can also be configured by administrators. As there may be a time difference between hydration of FIRE BOM, development of terraform artifacts, and terraform plan execution, the status of the service may be indeterminate. Once deployed, the system may need to determine the current state, security policies, mitigations, the protection status, and other details related to the service. Hence, it may be beneficial to design an intelligent and interactive interface that enables end users to handle different types of queries/requests, and helps organizations process, orchestrate, manage, and monitor network security controls across the cloud infrastructure, which may spread across multiple substrates.

As illustrated in the example of FIG. 3, a consolidated dialog form 315 may be sent to a user in response to a query submitted by the user. More specifically, if the user posts a query related to network security operations, the Sage service may post a message 305 asking the user to confirm or deny the intent of the original query (e.g., get a pull request approved, initiate a pipeline run). If, for example, the user responds with a message 310 and confirms the original intent of the query, the Sage service may post the consolidated dialog form 315. In some implementations, Sage may pre-populate one or more elements of the consolidated dialog form 315 with features/information extracted from the original query. This may reduce the amount of manual input needed to complete the consolidated dialog form 315 (thereby alleviating the burden on the user asking the query), and may provide the on-call user/engineer with a single data source to refer to.

The search functionality of Slack (and other messaging platforms), which may be customized by Sage, enables users to locate similar queries that have been asked, thereby removing the dependency of end users on on-call users/engineers and reducing the number of queries the on-call user/engineer is responsible for. Workflows provide users with more control over the queries they ask, and provide users with relevant data. Daily reminder messages from the Sage bot may be posted to Slack channel(s). The Sage service may also promote error pop-ups with guided correction. Additionally, Sage may populate specific fields such as substrate entities, network security parameters, etc. Furthermore, Sage may support progress indicators for tasks, on-call engineer alerts, intuitive search options, organized support ticket user experience, consolidated report user experience, etc.

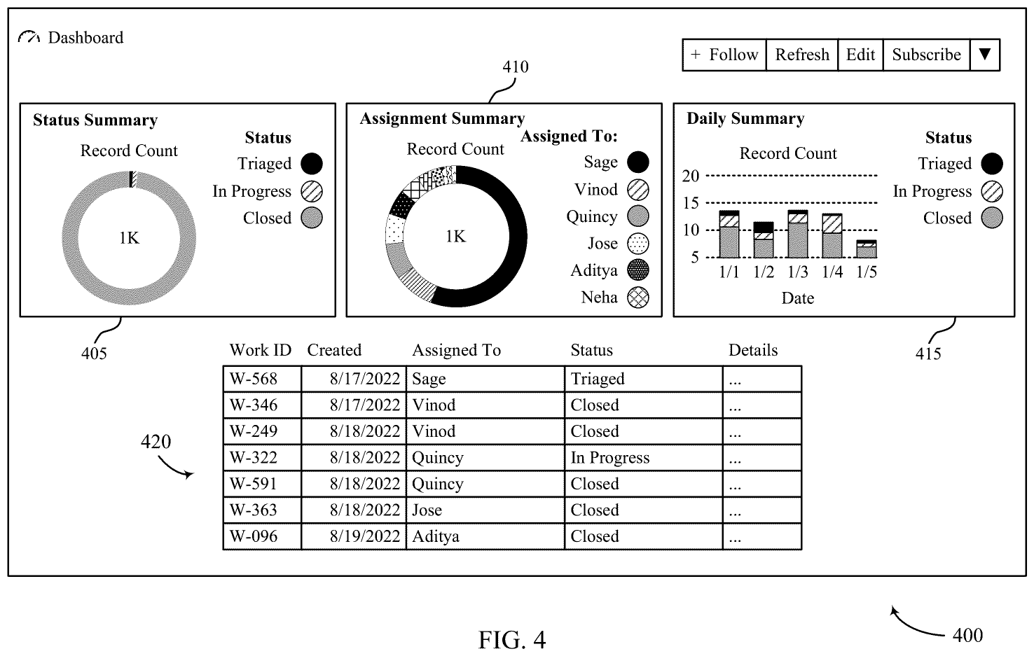

FIG. 4 illustrates an example of a dashboard interface 400 that supports techniques for processing queries related to network security in accordance with aspects of the present disclosure. The dashboard interface 400 may implement or be implemented by aspects of the computing environment 100, the computing environment 200, and/or the messaging interface 300. For example, the dashboard interface 400 may be displayed to a network security engineer or an administrator of a cloud computing system (such as the cloud platform 115 described with reference to FIG. 1). The content and/or format of the dashboard interface 400 may be customized according to user feedback, historic usage information, user type, etc. The various metrics and reports illustrated in the dashboard interface 400 may be generated by a query management service (such as the query management service 245 described with reference to FIG. 2).

As described herein with reference to FIGS. 1 through 3, an automated query resolution service (referred to herein as Sage) may provide an end-to-end solution for zero-touch triaging of network security-related queries in a cloud computing infrastructure spread across multiple substrates, such as AWS Cloud, Microsoft Azure, GCP, Ali Cloud, private data centers, etc. Sage may support an intent-based query handling system focused on overall user experience. Sage may provide automatic query handling that improves customer experience for all network security products and provides visibility into existing network configurations, policy deployments, etc. Sage may also process/handle user intent based on NLP algorithms that are specific to network security-related queries.

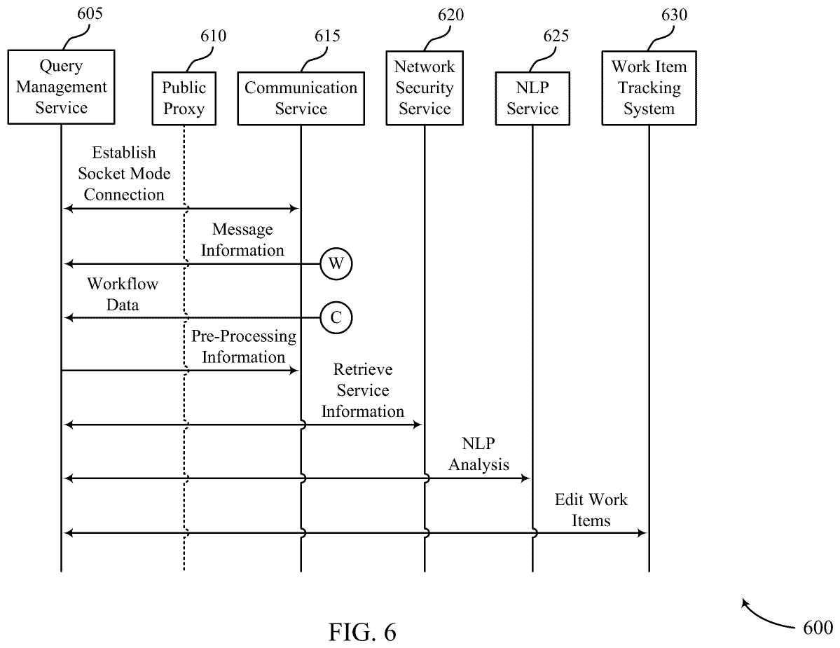

Additionally, Sage may be capable of mapping user intent based on network security service parameters (including auto-detection of service-related states in the query). Sage may use automated NLP score tuning to improve query responses based on historic user feedback to previous query responses, thereby improving the understanding of the correct intent of the user. Sage can be integrated with any number of third-party NLP or machine learning (ML) tools to process and handle chat utterances with in-built NLP handlers. As described with reference to FIG. 6, Sage may support flexible conversation and workflow interaction modes that provide different user experiences.

Other features/functions supported by Sage include corrections and suggestions to user queries based on data in services, sentimental analysis of customers based on query response (which can improve the pertinence of subsequent query responses), curated responses to end users (which may be internally related to multiple network security services and possibly other external information/services), user-curated responses by collecting details from various network security services, innovative mechanisms for communicating with other sub-systems through multiple services spread across multiple substrates for auto-resolving user queries related to security pipeline runs, connectivity checks, pull request review approval, error case resolution, general questions, network security status check, network security configuration, building network security policy, etc.

Sage may also provide users with network security policy deployment information by detecting/scanning across services spread over multiple substrates. In addition, Sage can provide solutions to generic queries that are dependent on multiple network security services spread across multiple substrates by analyzing/interpreting user utterances and mapping these utterances to corresponding query intents, as described with reference to FIG. 6.

In some implementations, Sage may be capable of reporting the status of a network policy deployment spread over multiple substrates, handling/updating the basic configuration(s) of network security policies spread over multiple substrates, helping with traffic issue triaging and troubleshooting across multiple substrates, etc. Sage may be extendible to perform analysis across network security services spread across multiple substrates (such as the network security services 280 described with reference to FIG. 2) for user queries to provide asynchronous responses and alerts to end users.

Sage may be configured to perform automatic scaling based on the number of queries received per minute. If the number of incoming queries increases, Sage may auto-scale and load balance the incoming queries to provide low-latency (i.e., real-time) responses to end users. As illustrated in the example of FIG. 4, Sage may also be configured to generate and display detailed reports on Sage activities and other query resolution statistics. For example, dashboard interface 400 includes a status summary report 405, an assignment summary report 410, a daily summary report 415, and a work item table 420.

The status summary report 405 may indicate the status of queries, requests, and/or work items (collectively referred to as records) received in a given time period (e.g., the last 24 hours). The status of a record may be triaged, in-progress, closed, etc. As described herein, triaging a query may involve conducting a preliminary evaluation of the query to determine the type (i.e., intent) and urgency of the query such that the query can be processed accordingly. In some examples, Sage may triage a query by providing pre-processing information to an end user (such as a notification that Sage is actively handling the query) or opening a work item on behalf of the end user (such that the query can be handled by an on-call engineer). The queries handled by Sage may be recorded by self-service-type work items that Sage can use to generate statistical reports.

The assignment summary report 410 may indicate the number of records received in a given time period as well as the percentage of records that were assigned to each on-call administrator/engineer. The daily summary report 415 may indicate the number and status of records received/processed each day over the course of a given time period (such as the last week or month). The work item table 420 may include details from specific records, such as a work item identifier, a record creation date, the name of the on-call engineer to whom the record was assigned, the status of the record, and other pertinent information.

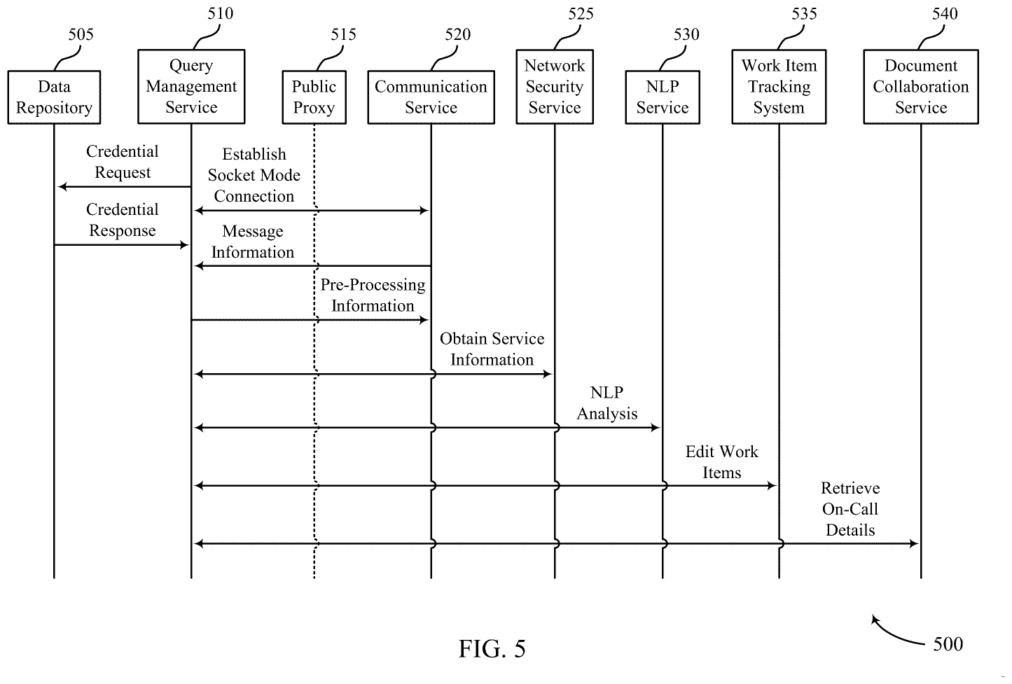

FIG. 5 illustrates an example of a process flow 500 that supports techniques for processing queries related to network security in accordance with aspects of the present disclosure. The process flow 500 may implement or be implemented by aspects of any of the computing environments, messaging interfaces, or dashboard interfaces described with reference to FIGS. 1 through 4. For example, the process flow 500 includes a query management service 510, which may be an example of the query management service 245 described with reference to FIG. 2. The process flow 500 also includes a communication service 520, which may be an example of the communication service 205 described with reference to FIG. 2. In the following description of the process flow 500, operations may be added, omitted, or performed in a different order (with respect to the exemplary order shown).

The process flow 500 shows an exemplary sequence of operations for starting the query management service 510. On start-up, the query management service 510 may configure all necessary settings, for example, by retrieving credentials from a data repository 505 (also referred to as a vault service). The query management service 510 may use these credentials to access various APIs within a distributed cloud infrastructure. The data repository 505 may be secured with in-built authentication capabilities/functions.

The query management service 510 may then establish a connection with the communication service 520 (i.e., a Slack Events API) via a public proxy 515 using a Slack web client or similar interface. After the query management service 510 establishes a socket connection with the communication service 520, the query management service 510 can actively monitor (i.e., listen to) messages that mention the query management service 510 (e.g., the Sage bot) in different messaging channels like Slack channels. The query management service 510 may use this socket connection to establish bidirectional communications with the communication service 520. In some implementations, connection management may not be required, as underlying messaging systems like Slack libraries can be used to manage these aspects.

Accordingly, the query management service 510 may receive message information (e.g., a Slack event notification) associated with a query that relates to network security operations. The query management service 510 may use a third-party NLP service 530 (such as Amazon Lex) to determine the intent of the query, as described with reference to FIG. 6. Once the intent of the query is determined, the query management service 510 can respond accordingly (for example, by gathering data from other services/systems). In some implementations, the query management service 510 may transmit pre-processing information (such as an estimated response time or a request for more information) back to the communication service 520 before handling/processing the query.

In some examples, the query management service 510 may recursively contact other Slack bots for dependent queries related to primary queries. For example, if the query management service 510 asks a first Slack bot for additional information, the first Slack bot may ask another Slack bot for other details, which may contact another Slack bot (as instructed by the query management service 510) to obtain the desired results. This process can be used if, for example, another Slack bot can be reached by an intermediate Slack bot (but not by the query management service 510).

The query management service 510 may establish respective socket connections with a work item tracking system 535 (i.e., Salesforce GUS), a document collaboration service 540 (i.e., Salesforce Quip), the NLP service 530 (i.e., Amazon Lex) and other network security services 525 spread across multiple cloud substrates. The query management service 510 may also obtain service-related information via a service API. For example, the query management service 510 may retrieve details on a particular service instance (equivalently referred to herein as a Falcon instance), such as a functional domain name or a service type associated with a service instance. Additionally, or alternatively, the query management service 510 may retrieve information from a monitoring/logging service (i.e., Argus) that tracks metrics for network security service pipeline runs. In some examples, the query management service 510 may retrieve on-call details from the document collaboration service 540 and notify the on-call engineer based on the on-call schedule. An on-call user/engineer may be involved if manual resolution is needed. Otherwise, all queries will be automatically handled by the query management service 510.

As described herein, Falcon may refer to a public cloud architecture that balances developer agility, security, and cost to serve. A Falcon instance is an implementation of Falcon, a trusted public cloud environment that includes the minimum requirements for functional domains to be instantiated. A Falcon instance includes Falcon foundation services, and may be associated with a substrate (e.g., GCP, AWS, Azure), region, environment type (e.g., production, test, development), and specific attributes. A functional domain is a logical boundary around a set of capabilities, features, and/or services that can be built and delivered independently. Functional domains have consumable interfaces that can either be internally or externally exposed. Functional domains can be used to enable a Services Development Model. Services can be composed into applications and saleable products. Functional domains may be based on a domain-driven design methodology. Falcon foundation is a defined set of capabilities that opens an instance for business for a functional domain to be deployed in a trusted and cost-efficient manner. There are primary capabilities included in the Falcon foundation that are used by all functional domains within a Falcon instance. There may also be secondary capabilities that are available for functional domains to leverage (but are not required to be used).

The query management service 510 can be used for troubleshooting and other situations where users are experiencing errors. Additionally, or alternatively, the query management service 510 can help resolve queries related to security pipeline runs, connectivity checks, pull request review approval, error case resolution, general questions, mitigations, status information, building network security policy, etc. If, for example, a query includes a request for pull request review approval or a pipeline run, the query management service 510 may post a consolidated dialog form into the appropriate Slack channel (as shown in the example of FIG. 3). The query management service 510 may also support configurable on-demand alerts for service owners based on network security service queries.

In some implementations, the query management service 510 may access an in-memory cache (such as the in-memory cache 265 described with reference to FIG. 2) that is synchronized with a distributed cache cluster (i.e., Redis), thereby ensuring high cache availability, scalability, and resilience. Internally, one instance of the query management service 510 may run as a single process with 3 threads operating in parallel. One thread may handle periodic data and configuration synchronization, one thread may handle network security posture data synchronization, and one thread may be dedicated to handling cache operations. The query management service 510 may use these parallel threads to formulate appropriate responses to queries.

The query management service 510 may support automated NLP score tuning based on query resolution answer history and automatic scaling based on the number of incoming queries per minute. As more queries arrive, the query management service 510 can auto-scale and load balance incoming queries to provide timely responses to end users. As described with reference to FIG. 4, the query management service 510 may generate detailed reports of automated query processing statistics. These dynamic dashboards (such as the dashboard interface 400 described with reference to FIG. 4) can be customized based on user preferences, feedback, etc. As such, different administrative users may be presented with different dashboards. In some examples, the query management service 510 may enable users to customize/edit dashboard features as needed.

The query management service 510 may support both workflow and conversational interactions. In workflow mode, the query management service 510 may provide customized user interface forms for workflow input from the user. The user interface forms presented to the end user may be customized based on historical usage and the type of end user. In conversation mode, the query management service 510 may respond to chat utterances with query results, follow-up questions, customized forms, and/or conversational feedback that is customized per the historical usage and type of the end user.

FIG. 6 illustrates an example of a process flow 600 that supports techniques for processing queries related to network security in accordance with aspects of the present disclosure. The process flow 600 may implement or be implemented by aspects of any of the computing environments, messaging interfaces, dashboard interfaces, or process flows described with reference to FIGS. 1 through 5. For example, the process flow 600 includes a query management service 605, which may be an example of the query management service 510 described with reference to FIG. 5. The process flow 600 also includes a communication service 615, which may be an example of the communication service 520 described with reference to FIG. 5. In the following description of the process flow 600, operations may be added, omitted, or performed in a different order (with respect to the exemplary order shown).

As described with reference to FIGS. 1 through 5, the query management service 605 (referred to herein as Sage) may support two different interaction modes, a conversation-based interaction mode and a workflow-based interaction mode. The process flow 600 illustrates exemplary sequences for both workflow and conversation-based operating modes. both modes enable users to provide feedback so the query management service 605 can be iteratively improved. The workflow-based interaction mode enables users to choose between four basic workflow options based on the type of query they submit. The workflow will open a dialog in which the user can fill in any requisite data before sharing the workflow request in the Slack channel. The conversational mode can be used to provide chat-based responses to user queries.

In accordance with the techniques described herein, the query management service 605 may establish a connection with the communication service 615 (i.e., a Slack Events API) via a public proxy 610 using a Slack web client or similar interface. After the query management service 605 establishes a socket connection with the communication service 615, the query management service 605 can actively monitor (i.e., listen to) messages that mention the query management service 605 (e.g., the Sage bot) in different Slack channels. The query management service 605 may use this socket connection to establish bidirectional communications with the communication service 615. In some implementations, connection management may not be required, as underlying Slack libraries can be used to manage these aspects.

Accordingly, the query management service 605 may receive workflow data and/or message information associated with queries that relate to network security operations. The query management service 605 may use a third-party NLP service 625 (such as Amazon Lex) to determine/evaluate the intent of the query. Table 1 includes a list of exemplary user inputs (i.e., chat utterances) and corresponding query intents.

TABLE 1
Mapping User Input to Query Intent

| Example User Input | Query Intent | Intent Description |
|---|---|---|
| “need approval on my pr” | pr_approval | Approve pull request |
| “pr require approval” | | |
| “rerun pipeline” | pipeline_run | Run network security |
| “run pipeline for me” | | pipeline |
| “manual help” | get_expert_help | Get manual help |
| “get me expert help” | | |
| “close ticket” | close_ticket | Ask Sage to close work |
| “close this” | | item |
| “is my service reachable from | confirm_corp_reachable | Check the service |
| corp network” | | connectivity from |
| | | corporate network |
| “what local clusters are | get_functional_domains | Check available functional |
| available in a data center” | | domains in a falcon |
| “what clusters are available in | | instance |
| this data center” | | |
| “list all services reachable from | get_services | Check all services that can |
| my service” | | connect from a service |
| “read all reachable services list” | | |
| “is there connectivity between | connectivity_query | Check connectivity |
| my service” | | between two services |
| “can you please check the | | |
| connection between services” | | |
| “NetSec pipeline status” | pipeline_info | Get network security |
| “pipeline last run” | | pipeline status for service |
| “enumerate fi” | get_falcon_instances | Get all available falcon |
| “list all available falcon | | instances |
| instances” | | |
| “public proxy issue” | check_public_proxy | Help when you have a |
| “outbound access errors” | | public issue |
| “We're getting the error:” | error | Help user debug errors or |
| “found a problem” | | failures |
| “share with me FAQs” | sage_info | Get information about |
| “need help on sage” | | Sage |
| “access service on corp” | corp_network_access_info | Get help on corporate |
| “service access within corp | | access |
| network” | | |
| “access service in another | inter_cluster_access_info | Get help on inter- |
| functional domain” | | functional domain access |
| “how to access service in | | |
| another data centers/inside | | |
| isolations” | | |
| “how can I access the internet” | internet_access_info | Get help on internet access |
| “internet access” | | |
| “how do I define ports for my | listening_ports_info | Get help on listening ports |
| service” | | |
| “what port is my service | | |
| running on” | | |
| “how to create a new network | network_policies_info | Get help on network |
| policy” | | policies |
| “how to edit my network | | |
| policy” | | |
| “when is NetSec office hour” | office_hours_info | Get help on network |
| “need info on office hour” | | security office hours |
| “what are security groups” | security_groups_info | Get help on security |
| | | groups |
| “what is specific NetSec | netsec_service_info | Get help on network |
| service” | | security services |
| “how does specific NetSec | | |
| service work” | | |
| “how can I access another | intra_cluster_access_info | Get help on intra- |
| service in same data | | functional domain access |
| centers/inside clusters” | | |
| “intra-cluster access” | | |
| “how to integrate with specific | netsec_service_onboarding_info | Get help on onboarding to |
| NetSec service” | | specific network security |
| “Specific NetSec service | | service |
| onboarding” | | |
| “what is falcon” | falcon_info | Help with falcon |
| “how can I get support for | | information |
| falcon” | | |
| “which security group should I | get_security_groups | Help find which security |
| put my service in” | | group should be used for a |
| | | particular service |
| “how to attach security group to | how_to_attach_security_groups_info | Help attaching security |
| my service” | | group to a service |
| “attach security groups to | | |
| service” | | |

The query intent mapping techniques disclosed herein may be supported by a third-party NLP service 625, which can be locally/internally customized by the query management service 605. The third-party NLP service 625 may help the query management service 605 establish the context and appropriate course of action for a given request. The query management service 605 may also extract key features from the query and provide this information to the on-call engineer (such that the on-call engineer can manually resolve the underlying issue at a later time).

Once the intent of the query is determined and/or confirmed, the query management service 605 can respond accordingly (for example, by gathering data from other services/systems). In some implementations, the query management service 605 may transmit pre-processing information (such as an estimated response time or a request for more information) back to the communication service 615 before handling/processing the query. For example, if the intent of the query corresponds to a workflow interaction mode, the query management service 605 may cause a consolidated dialog form (such as the consolidated dialog form 315 described with reference to FIG. 3) to be displayed in the source messaging channel (e.g., Slack channel).

In some examples, the query management service 605 may recursively contact other Slack bots for dependent/related queries. For example, if the query management service 605 asks a first Slack bot for additional information, the first Slack bot may ask another Slack bot for other details, which may contact another Slack bot (as instructed by the query management service 605) to obtain the desired results. This process can be used if, for example, another Slack bot can be reached by an intermediate Slack bot (but not by the query management service 605).

The query management service 605 may establish respective socket connections with a work item tracking system 630 (i.e., Salesforce GUS), a document collaboration service (i.e., Salesforce Quip), the NLP service 625 (i.e., Amazon Lex) and other network security services 620 spread across multiple cloud substrates. The query management service 605 may also obtain service-related information via a service API. For example, the query management service 605 may retrieve details on a particular service instance (equivalently referred to herein as a Falcon instance), such as a functional domain name or a service type associated with a service instance. Additionally, or alternatively, the query management service 605 may retrieve information from a monitoring/logging service (i.e., Argus) that tracks metrics for network security service pipeline runs. In some examples, the query management service 605 may retrieve on-call details from the document collaboration service and notify the on-call engineer, as indicated by an on-call schedule.

The query management service 605 can be used for troubleshooting and other situations where users are experiencing errors. Additionally, or alternatively, the query management service 605 can help resolve queries related to security pipeline runs, connectivity checks, pull request review approval, error case resolution, general questions, mitigations, status information, building network security policy, etc. If, for example, a query includes a request for pull request review approval or a pipeline run, the query management service 605 may post a consolidated dialog form into the appropriate Slack channel (as shown in the example of FIG. 3). The query management service 605 may also support on-demand alerts for service owners based on network security service queries.

In some implementations, the query management service 605 may access an in-memory cache (such as the in-memory cache 265 described with reference to FIG. 2) that is synchronized with a distributed cache cluster (i.e., Redis), thereby ensuring high cache availability, scalability, and resilience. Internally, the query management service 605 may run as a single process with 3 threads operating in parallel. One thread may handle periodic data and configuration synchronization, one thread may handle network security posture data synchronization, and one thread may be dedicated to handling cache operations. The query management service 605 may use these parallel threads to formulate appropriate responses to queries.

The query management service 605 may support automated NLP score tuning based on query resolution answer history and automatic scaling based on the number of incoming queries per minute. As more queries arrive, the query management service 605 can auto-scale and load balance incoming queries to provide timely responses to end users. As described with reference to FIG. 4, the query management service 605 may generate detailed reports of automated query processing statistics. These dynamic dashboards (such as the dashboard interface 400 described with reference to FIG. 4) can be customized based on user preferences, feedback, user type, etc. Thus, different administrative users may be presented with different dashboards. In some examples, the query management service 605 may enable users to customize/edit dashboard features as needed.

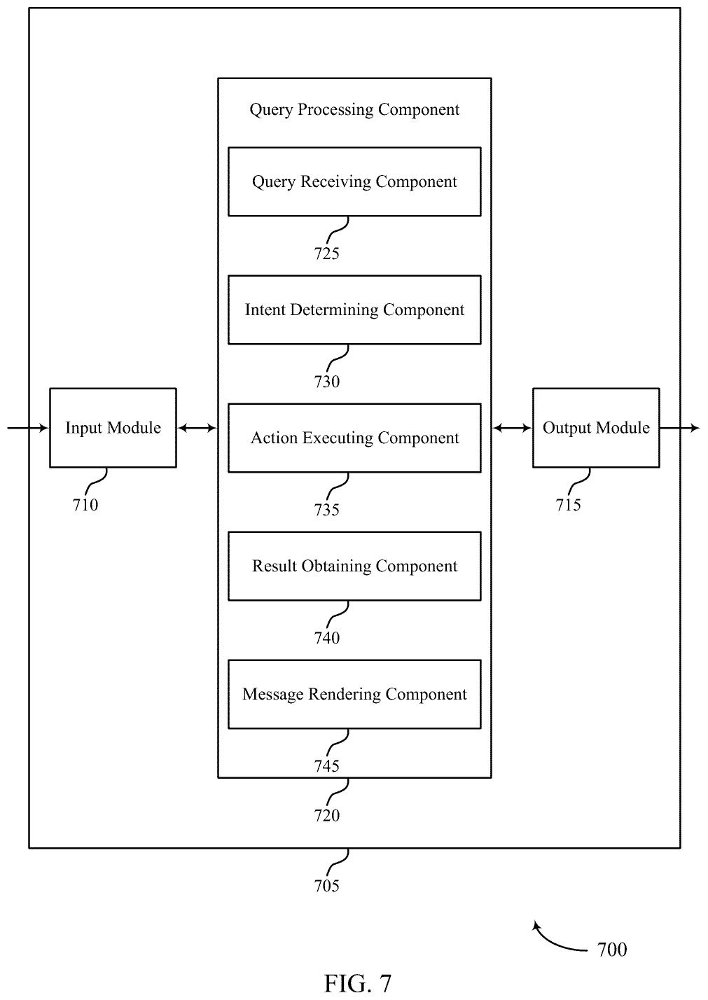

FIG. 7 illustrates a block diagram 700 of a device 705 that supports techniques for processing queries related to network security in accordance with aspects of the present disclosure. The device 705 may include an input module 710, an output module 715, and a query processing component 720. The device 705 may also include a processor. Each of these components may be in communication with one another (e.g., via one or more buses).

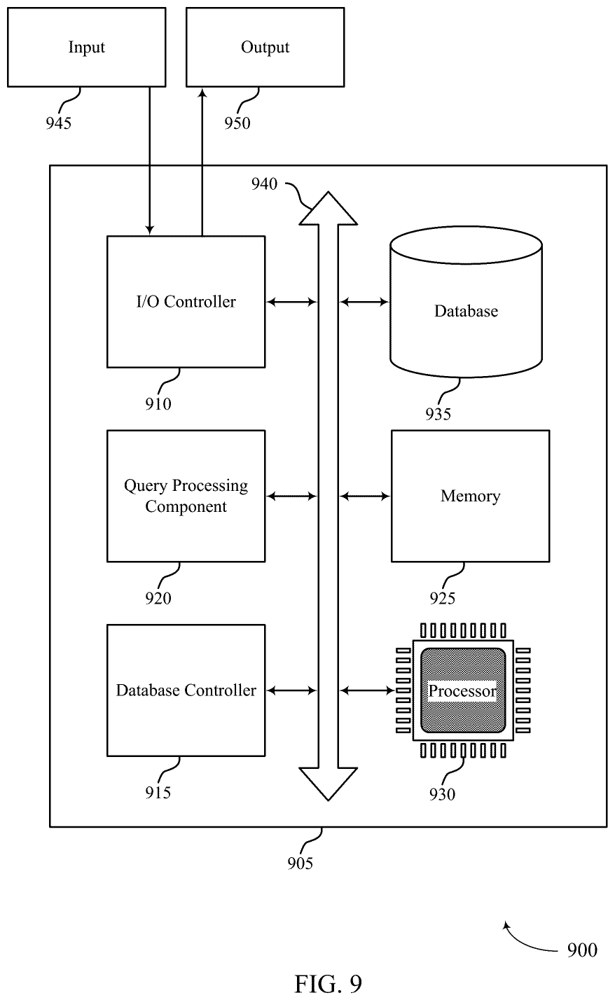

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the query processing component 720 to support techniques for processing queries related to network security. In some cases, the input module 710 may be a component of an input/output (I/O) controller 910, as described with reference to FIG. 9.

The output module 715 may manage output signals for the device 705. For example, the output module 715 may receive signals from other components of the device 705, such as the query processing component 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910, as described with reference to FIG. 9.

For example, the query processing component 720 may include a query receiving component 725, an intent determining component 730, an action executing component 735, a result obtaining component 740, a message rendering component 745, or any combination thereof. In some examples, the query processing component 720, or various components thereof, may be configured to perform various operations (e.g., receiving, monitoring, transmitting) using or otherwise in cooperation with the input module 710, the output module 715, or both. For example, the query processing component 720 may receive information from the input module 710, send information to the output module 715, or be integrated in combination with the input module 710, the output module 715, or both to receive information, transmit information, or perform various other operations as described herein.

The query processing component 720 may support data processing and troubleshooting at a query management service in accordance with examples disclosed herein. The query receiving component 725 may be configured to support receiving, via a proxy between the query management service and a communication service, an indication of a query from a user of the communication service. The intent determining component 730 may be configured to support determining an intent of the query based on using a third-party NLP model (such as the NLP service 530 described with reference to FIG. 5) to analyze the query from the user. The action executing component 735 may be configured to support executing, within a distributed computing environment that includes the query management service and a set of multi-substrate network security services, a sequence of actions that correspond to the intent of the query. The result obtaining component 740 may be configured to support obtaining one or more query results based on executing the sequence of actions within the distributed computing environment. The message rendering component 745 may be configured to support transmitting an indication of the one or more query results to the communication service connected to the query management service via the proxy, where the one or more query results are rendered according to feedback information from the user.

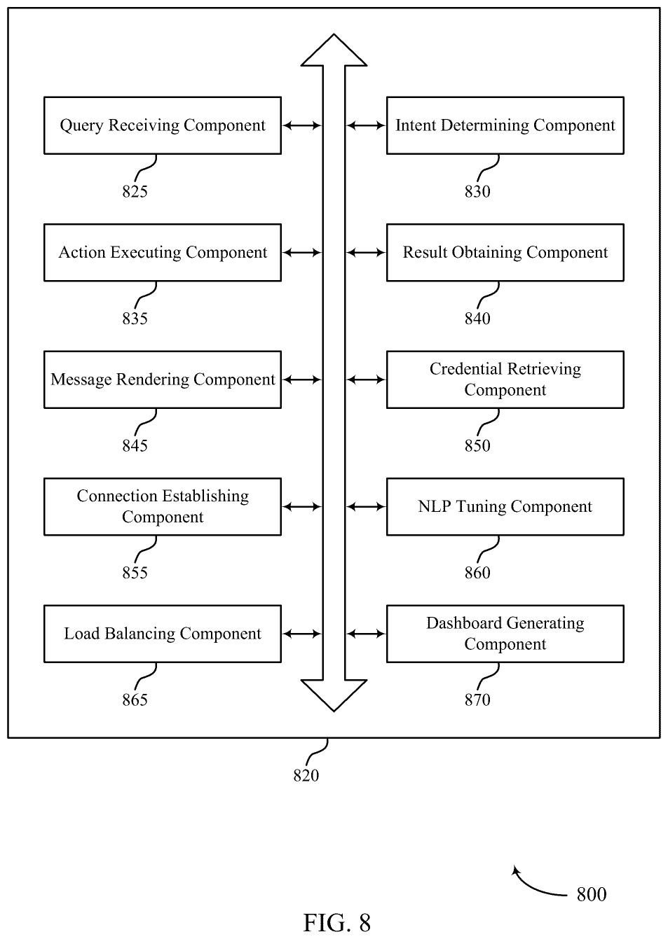

FIG. 8 illustrates a block diagram 800 of a query processing component 820 that supports techniques for processing queries related to network security in accordance with aspects of the present disclosure. The query processing component 820 may be an example of aspects of a query processing component or a query processing component 720, or both, as described herein. The query processing component 820, or various components thereof, may be an example of means for performing various aspects of techniques for processing queries related to network security as described herein. For example, the query processing component 820 may include a query receiving component 825, an intent determining component 830, an action executing component 835, a result obtaining component 840, a message rendering component 845, a credential retrieving component 850, a connection establishing component 855, an NLP tuning component 860, a load balancing component 865, a dashboard generating component 870, or any combination thereof. Each of these components may communicate, directly or indirectly, with one another (e.g., via one or more buses).

The query processing component 820 may support data processing and troubleshooting at a query management service in accordance with examples disclosed herein. The query receiving component 825 may be configured to support receiving, via a proxy between the query management service and a communication service, an indication of a query from a user of the communication service. The intent determining component 830 may be configured to support determining an intent of the query based on using a third-party NLP model to analyze the query from the user. The action executing component 835 may be configured to support executing, within a distributed computing environment that includes the query management service and a set of multi-substrate network security services, a sequence of actions that correspond to the intent of the query. The result obtaining component 840 may be configured to support obtaining one or more query results based on executing the sequence of actions within the distributed computing environment. The message rendering component 845 may be configured to support transmitting an indication of the one or more query results to the communication service connected to the query management service via the proxy, where the one or more query results are rendered according to feedback information from the user.

In some examples, to support executing the sequence of actions, the credential retrieving component 850 may be configured to support retrieving a set of credentials from a secure data repository in the distributed computing environment. In some examples, to support executing the sequence of actions, the result obtaining component 840 may be configured to support extracting the one or more query results based on using the set of credentials from the secure data repository to access the set of multi-substrate network security services via one or more APIs.

In some examples, to support executing the sequence of actions, the action executing component 835 may be configured to support transmitting pre-processing information to the communication service before processing the query from the user, the pre-processing information including an initial response to the query, an indication that the query management service is actively processing the query, an indication of an expected query response time, a request for additional information from the user, or a combination thereof.

In some examples, to support obtaining the one or more query results, the result obtaining component 840 may be configured to support obtaining, via at least one service API, information that pertains to one or more network security service instances or functional domains of the distributed computing environment spread across multiple substrates.

In some examples, the intent of the query is checking a connectivity status of a network security service, confirming whether a network security service is accessible from a network within the distributed computing environment, connectivity troubleshooting, debugging network security-related problems, running a security pipeline operation, obtaining security deployment information, acquiring security service details, determining a status of a network security posture, building network policy, requesting approval of a review pull request, opening or closing a work item, resolving an error, determining a status of an issue, or a combination thereof.

In some examples, to support executing the sequence of actions, the action executing component 835 may be configured to support causing a consolidated dialog form to be rendered within a user interface of the communication service, where at least a portion of the consolidated dialog form is pre-populated with information extracted from the query.

In some examples, to support executing the sequence of actions, the action executing component 835 may be configured to support recursively resolving at least a portion of the query based on establishing a connection with an external application that is integrated with the communication service.

In some examples, to support obtaining the one or more query results, the result obtaining component 840 may be configured to support retrieving the one or more query results from a monitoring service that stores metrics from multiple data sources in the distributed computing environment, where the one or more query results include metrics associated with a network security service pipeline run.

In some examples, to support executing the sequence of actions, the action executing component 835 may be configured to support transmitting an alert to one or more service owners in response to determining that the query pertains to network security service operations.

In some examples, a first thread of the query management service controls periodic data synchronization, a second thread of the query management service controls security posture synchronization, and a third thread of the query management service controls cache handling operations. In some examples, the first thread, the second thread, and the third thread all operate in parallel.

In some examples, to support obtaining the one or more query results, the result obtaining component 840 may be configured to support retrieving the one or more query results from an in-memory cache that is synchronized with a third-party distributed cache.

In some examples, to support executing the sequence of actions, the action executing component 835 may be configured to support retrieving, from a third-party document collaboration service, contact information for an on-call user that is responsible for handling queries pertaining to network security services. In some examples, to support executing the sequence of actions, the action executing component 835 may be configured to support transmitting an indication of the query to the on-call user.

In some examples, the connection establishing component 855 may be configured to support establishing a bidirectional socket connection with at least one of the communication service, a third-party messaging application, a third-party work item tracking system, a third-party document collaboration service, or a third-party NLP application via the proxy, where the one or more query results are obtained via the bidirectional socket connection.

In some examples, the NLP tuning component 860 may be configured to support performing an automated NLP tuning process to determine a score for the one or more query results using historic query resolution feedback from the user of the communication service. In some examples, the message rendering component 845 may be configured to support causing the one or more query results to be rendered according to a result of the automated NLP tuning process.

In some examples, the load balancing component 865 may be configured to support performing a combination of automatic scaling and load balancing operations to reduce a query response time of the query management service if a number of queries received per minute satisfies a threshold.

In some examples, the dashboard generating component 870 may be configured to support generating a dynamic dashboard that includes statistics associated with queries received and processed by the query management service within a time interval, where at least one user interface element of the dynamic dashboard is customized by the user. In some examples, the set of multi-substrate network security services are distributed across multiple third-party hosting environments.

In some examples, the query management service supports a workflow-based interaction mode and a conversation-based interaction mode, the workflow-based interaction mode providing user interface forms that are customized based on historic usage information associated with the user and a type of the user, the conversation-based interaction mode providing conversational questions and responses that are customized based on the historic usage information and the type of the user.

FIG. 9 illustrates a diagram of a system 900 including a device 905 that supports techniques for processing queries related to network security in accordance with aspects of the present disclosure. The device 905 may be an example of or include the components of a device 705 as described herein. The device 905 may include components for bidirectional data communications including components for transmitting and receiving communications, such as a query processing component 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause the processor 930 to perform various functions described herein. In some cases, the memory 925 may contain, among other things, a basic I/O system (BIOS) which may control basic hardware or software operation such as the interaction with peripheral components or devices.

The processor 930 may include an intelligent hardware device, (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting techniques for processing queries related to network security).

The query processing component 920 may support data processing and troubleshooting at a query management service in accordance with examples disclosed herein. For example, the query processing component 920 may be configured to support receiving, via a proxy between the query management service and a communication service, an indication of a query from a user of the communication service. The query processing component 920 may be configured to support determining an intent of the query based on using a third-party NLP model to analyze the query from the user. The query processing component 920 may be configured to support executing, within a distributed computing environment that includes the query management service and a set of multi-substrate network security services, a sequence of actions that correspond to the intent of the query. The query processing component 920 may be configured to support obtaining one or more query results based on executing the sequence of actions within the distributed computing environment. The query processing component 920 may be configured to support transmitting an indication of the one or more query results to the communication service connected to the query management service via the proxy, where the one or more query results are rendered according to feedback information from the user.

By including or configuring the query processing component 920 in accordance with examples as described herein, the device 905 may support techniques for automatically interpreting/handling network security related-queries from users of a communication service, thereby reducing the number of network security-related queries that are manually resolved by system administrators or network security engineers. Furthermore, using a query management service to autonomously handle requests related to network security may enable end users to obtain query results, troubleshoot connectivity issues, and/or submit service requests in real-time (i.e., without waiting for another user to manually resolve each query). The query management service described herein may also customize query results according to feedback provided by end users, resulting in higher user satisfaction and improved user experience.

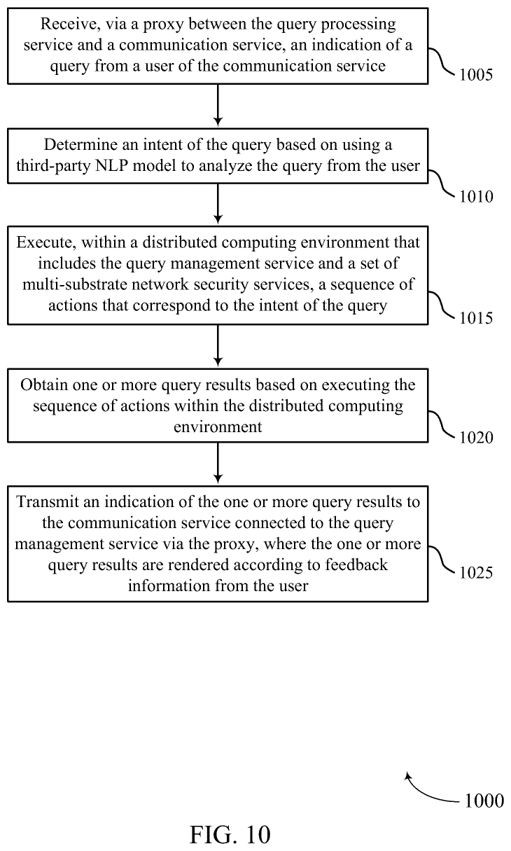

FIG. 10 illustrates a flowchart showing a method 1000 that supports techniques for processing queries related to network security in accordance with aspects of the present disclosure. The operations of the method 1000 may be implemented by a query management service or components thereof. For example, the operations of the method 1000 may be performed by the query management service 245, as described with reference to FIG. 2. In some examples, the query management service may execute a set of instructions to control functional elements of the query management service to perform the described functions. Additionally, or alternatively, the query management service may perform aspects of the described functions using special-purpose hardware.

At 1005, the query management service may receive, via a proxy between the query management service and a communication service, an indication of a query from a user of the communication service. The operations of 1005 may be performed in accordance with examples disclosed herein. In some examples, aspects of the operations of 1005 may be performed by a query receiving component 825, as described with reference to FIG. 8.

At 1010, the query management service may determine an intent of the query based on using a third-party NLP model and customized logic to analyze the query from the user. The operations of 1010 may be performed in accordance with examples disclosed herein. In some examples, aspects of the operations of 1010 may be performed by an intent determining component 830, as described with reference to FIG. 8.

At 1015, the query management service may execute, within a distributed computing environment that includes the query management service and a set of multi-substrate network security services, a sequence of actions that correspond to the intent of the query. The operations of 1015 may be performed in accordance with examples disclosed herein. In some examples, aspects of the operations of 1015 may be performed by an action executing component 835, as described with reference to FIG. 8.

At 1020, the query management service may obtain one or more query results based on executing the sequence of actions within the distributed computing environment. The operations of 1020 may be performed in accordance with examples disclosed herein. In some examples, aspects of the operations of 1020 may be performed by a result obtaining component 840, as described with reference to FIG. 8.

At 1025, the query management service may transmit an indication of the one or more query results to the communication service connected to the query management service via the proxy, where the one or more query results are rendered according to feedback information from the user. The operations of 1025 may be performed in accordance with examples disclosed herein. In some examples, aspects of the operations of 1025 may be performed by a message rendering component 845, as described with reference to FIG. 8.

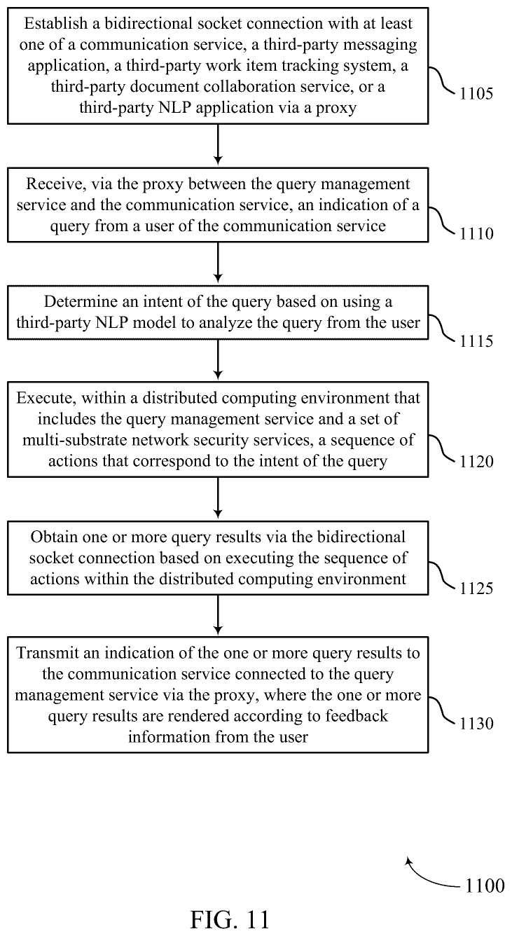

FIG. 11 illustrates a flowchart showing a method 1100 that supports techniques for processing queries related to network security in accordance with aspects of the present disclosure. The operations of the method 1100 may be implemented by a query management service or components thereof. For example, the operations of the method 1100 may be performed by the query management service 510, as described with reference to FIG. 5. In some examples, the query management service may execute a set of instructions to control functional elements of the query management service to perform the described functions. Additionally, or alternatively, the query management service may perform aspects of the described functions using special-purpose hardware.

At 1105, the query management service may establish a bidirectional socket connection with at least one of a communication service, a third-party messaging application, a third-party work item tracking system, a third-party document collaboration service, or a third-party NLP application via a proxy. The operations of 1105 may be performed in accordance with examples disclosed herein. In some examples, aspects of the operations of 1105 may be performed by a connection establishing component 855, as described with reference to FIG. 8.

At 1110, the query management service may receive, via the proxy between the query management service and the communication service, an indication of a query from a user of the communication service. The operations of 1110 may be performed in accordance with examples disclosed herein. In some examples, aspects of the operations of 1110 may be performed by a query receiving component 825, as described with reference to FIG. 8.

At 1115, the query management service may determine an intent of the query based on using a third-party NLP model and customized logic to analyze the query from the user. The operations of 1115 may be performed in accordance with examples disclosed herein. In some examples, aspects of the operations of 1115 may be performed by an intent determining component 830, as described with reference to FIG. 8.

At 1120, the query management service may execute, within a distributed computing environment that includes the query management service and a set of multi-substrate network security services, a sequence of actions that correspond to the intent of the query. The operations of 1120 may be performed in accordance with examples disclosed herein. In some examples, aspects of the operations of 1120 may be performed by an action executing component 835, as described with reference to FIG. 8.

At 1125, the query management service may obtain one or more query results via the bidirectional socket connection based on executing the sequence of actions within the distributed computing environment. The operations of 1125 may be performed in accordance with examples disclosed herein. In some examples, aspects of the operations of 1125 may be performed by a result obtaining component 840, as described with reference to FIG. 8.

At 1130, the query management service may transmit an indication of the one or more query results to the communication service connected to the query management service via the proxy, where the one or more query results are rendered according to feedback information from the user. The operations of 1130 may be performed in accordance with examples disclosed herein. In some examples, aspects of the operations of 1130 may be performed by a message rendering component 845, as described with reference to FIG. 8.

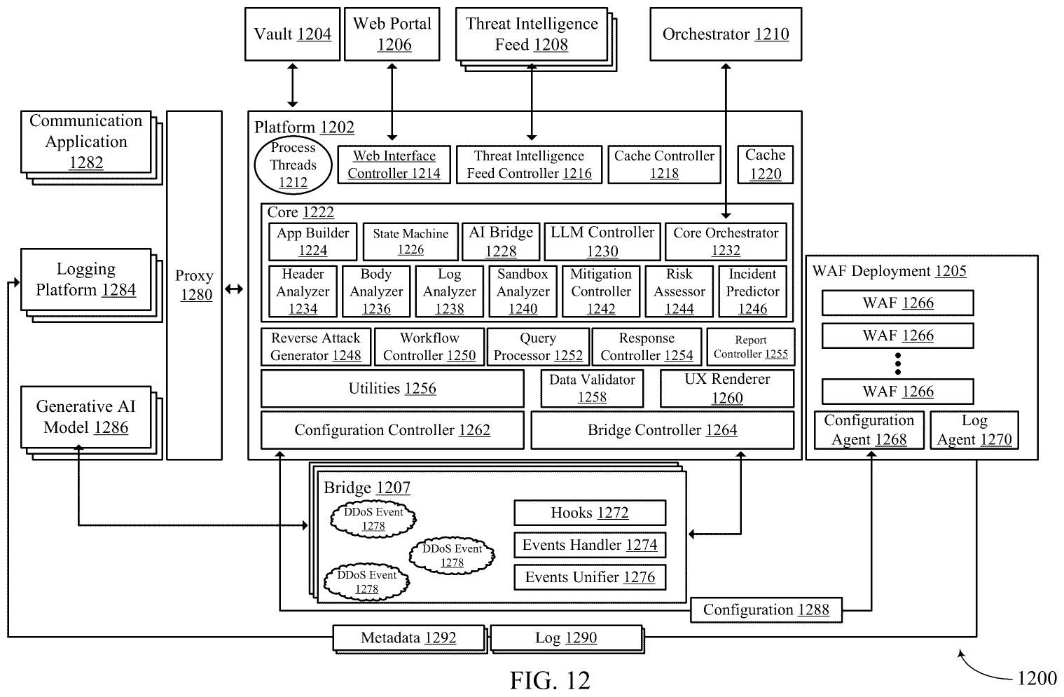

FIG. 12 shows an example of a system 1200 that supports distributed denial of service protection management in accordance with aspects of the present disclosure.

In some examples, a system may include the platform 1202 that may coordinate one or more operations to manage WAF operations or other DDoS protection operations. Additionally, or alternatively, and in some examples, the platform 1202 may be a service, such as a service implemented on one or more cloud systems. For example, the platform 1202 may perform operations to address the complexities of DDoS attacks (e.g., L7 DDoS attacks) within large-scale, multi-substrate deployments. For example, the platform 1202, the WAFs 1266 (e.g., WAFs from multiple vendors or multi-vendor WAFs), one or more other elements of the system 1200, or any combination thereof, may be operated in association with one or more substrates. Though the WAFs 1266 are described as examples, other services associated with DDoS protection may also be employed, and operations and functionalities described in association with the WAFs 1266 may be applied equally to other services.

The system 1200 may provide a unified framework for managing L7 DDoS attacks across multi-substrate deployments. For example, the system 1200 may integrate with existing protection solutions (e.g., the WAFs 1266) the system 1200 streamlines the handling, mitigation, incident response, and query resolution processes associated with DDoS protection.

The system 1200 may include a scalable platform 1202, which may orchestrate the coordination and management of DDoS protection solutions (e.g., the WAFs 1266) deployed across diverse substrates. The system 1200 may include automated incident detection and mitigation capabilities, utilizing real-time traffic analysis and anomaly detection algorithms. The system 1200 may include alerts from the WAFs 1266 capturing and analysis to collect data summary. The system 1200 may include configurable alerting mechanisms to notify users or administrators of potential attacks, enabling timely response and mitigation actions. The system 1200 may include dynamic signature management functionalities (e.g., determining characteristics of DDoS events 1278) for adapting to evolving attack vectors and patterns. For example, DDoS events 1278 may have signatures, characteristics, or patterns to them, including pinging, logins, website crawling, and others. The system 1200 may detect such signatures, characteristics, or patterns, and dynamically generate configurations 1288 based at least in part on such signatures, characteristics, or patterns. The system 1200 may include query resolution modules enabling automated responses to inquiries related to DDoS incidents, configurations, and mitigation strategies. In some examples, configuration-related operations associated with the platform 1202 may persist (e.g., using JSON NoSQL databases or in other formats). Further, in some examples, non-confidential configurations may be stored in version control repositories, facilitating external tracking of changes with case, including history.

The system 1200 may perform various operations connected with management of the WAFs 1266. For example, the system 1200 may analyze incoming traffic patterns to detect potential L7 DDoS attacks. The system 1200 may initiate automated mitigation actions based on predefined rulesets and policies. The system 1200 may perform reverse attack (e.g., by producing “dummy” responses (e.g., heavy responses with large payloads) to slow down attackers. The system 1200 may coordinate the response efforts of the various WAFs 1266 deployed across multiple substrates. The system 1200 may dynamically adjust configuration settings and signature updates to improve mitigation effectiveness. The system 1200 may generate comprehensive incident reports and logs for post-incident analysis and audit purposes. The system 1200 may provide automated responses to queries regarding L7 DDoS incident details, mitigation strategies, and configuration parameters. In some examples, tracking records, like work items, are maintained in in the platform 1202, such as in the cache 1220 or at another location internal or external to the platform 1202.

In some examples, the platform 1202 may include elements that may perform various functions to provide DDoS protection management. The platform 1202 may be hosted on a single device, on multiple devices, on a system, or a platform, such as a cloud platform (e.g., an internal cloud platform, a third-party cloud platform, or other type of cloud platform). In some examples, the platform 1202 functions as a scalable service, including the core 1222 and other components.

In some examples, the platform 1202 may include a bot service or bot system that manages parallel operations and data flow of the platform 1202. In some examples, the bot service or bot system may be a multi-process or multi-thread-based service and it may store one or more credentials in the vault 1204. In some examples, the bot service or bot system may engage with users through messaging platforms (e.g., the communication application 1282) via the proxy 1280.

In some examples, the vault 1204 may be used to securely store credentials associated with the communications applications 1282, one or more communication bots, one or more services, one or more other elements of the system 1200, or any combination thereof. In some examples, to perform one or more operations described herein, the system 1200 may retrieve or store credentials from or in the vault 1204.

In some examples, the WAF deployment 1205 may include one or more WAFs 1266 deployed to protect a computing system. The WAFs 1266 (also referred to as web application firewalls) may be third-party services that perform operations to detect and mitigate DDoS attacks on a system. Different WAFs 1266 may be better suited to different operations, different types of DDoS (or other) attacks, and the system 1200 may dynamically generate the configurations 1288 for these different WAFs 1266 based on such characteristics of the WAFs 1266.

In some examples, the web portal 1206 may allow a range of functionalities, monitoring tools, and APIs, one or more other operations described herein in association with the system 1200, or any combination thereof, to be accessible to users or administrators. For example, through the web portal 1206, administrators or users may submit queries, view dashboard overviews, manage configurations, manage any element of the system 1200 (e.g., configure, monitor, or otherwise interact), monitor and set alerts, report and analyze, and access documentation offering guidance on various aspects of platform usage. In some examples, the web interface controller 1214 may receive input from the web portal and may transmit output from the platform 1202 to the web portal 1206.

In some examples, the bridge 1207 may serve as a conduit for event data or other information to be transmitted between the platform 1202 and the WAFs 1266 (or one or more other elements of the system 1200). The bridge may be implemented as a message bus, data channel, or similar mechanism. The bridge 1207 may aid in aggregating events (e.g., the DDoS events 1278) produced by the WAFs 1266. In some examples, one or more DDoS event records may be generated and processed (e.g., to analyze the DDoS events 1278 to generate the configuration 1288). In some examples, the bridge 1207 may operates across numerous instances, adjusting its scale based on the quantity of WAFs 1266 and the load it encounters.

In some examples, the threat intelligence feeds 1208 may be third party services that publish information about ongoing or recent attacks, such as timing information, signature information, characteristic information, or other threat intelligence information.

In some examples, the process threads 1212 may include threads that are separated and secured on a per-user basis, such that process threads 1212 of one user do not mingle with threads of another user. The process threads 1212 may be associated with any of the operations performed by a system for one or more users. For example, the process threads 1212 may be used for performing operations of a system in parallel. Further, in some examples, different process threads may be used for different users or administrators that may be using one or more aspects of the system (e.g., sending queries, viewing dashboards, or any other operation of the system).

In some examples, the threat intelligence feed controller 1216 may asynchronously retrieve threat intelligence data from one or more threat intelligence feeds 1208, which may originate from multiple sources. Such information may be used in at least a portion of the analysis of the DDoS events 1278 or records thereof to determine or generate the configuration 1288.

In some examples, the cache controller 1218 may manage one or more caches for storing information for the system 1200, including the cache 1220 and other caches that may be individually or collectively associated with any element of the 1200 or described elsewhere herein.

In some examples, the cache 1220 may store information that is to be used by the platform 1202. Any elements or multiple such elements of the system 1200 may store information at the cache 1220 for later retrieval. In some examples, the cache 1220 may include a plurality of caches, and individual caches of the plurality of caches may be dedicated for use by one or more elements of the system 1200.

In some examples, the app builder 1224 may aid in building processing flows, applications, or other processing elements that may be used by the system 1200 to respond to manage DDoS protection. In some examples, the app builder 1224 may serve as a framework for interacting with messaging apps (e.g., such as the communication application 1282).

In some examples, the state machine 1226 may aid in managing states of the system 1200 or components thereof. In some examples, such information about different states of the system 1200 or components thereof may be stored in the cache 1220 or in a dedicated cache. In some examples, the state machine 1226 may dynamically adjust and synchronize with a distributed cache to accommodate scaling operations of the platform 1202. For example, the platform 1202 may operate in multiple instances, and each instance may include a state machine 1226 that may update or configure the associated instance based on user or administrator input or automated scaling rules (e.g., that may designate one or more conditions or thresholds for performing one or more scaling operations). Further, an instance of the platform 1202 may share data stored in the cache 1220 with other instances to synchronize information or operations between multiple instances. In some examples, the state machine 1226 may automatically synchronize with distributed caches in association with scaling operations of the platform 1202 or other elements of the system 1200.

In some examples, the AI bridge 1228, the LLM controller 1230, or both, may interface with any generative AI model (or other processing model) such as the generative AI models 1286 to assist in performing one or more operations or managing one or more configurations for processing models associated with DDoS protection management as described herein, such as determining intents of queries, tuning intents or queries, determining one or more actions to be performed, any other operation described herein, or any combination thereof, as desired (e.g., through the use of an Al tuner). In some examples, a retrieval augmented generation (RAG) model, in-context learning (ICL) approaches, or both, may be employed to manage DDoS protection. In some examples, the LLM controller 1230 may manage coordination and correction of training data for the generative AI models 1286.

In some examples, the core orchestrator 1232 may integrate with the orchestrator 1210, which may be a third party orchestrator, enabling scalability to accommodate new orchestration functionalities. For example, the core orchestrator 1232 may transmit information to the orchestrator 1210, which may then return an orchestrated workflow for one or more elements of the system 1200.

In some examples, the core 1222 may include an events analyzer, which may include the header analyzer 1234 and the body analyzer 1236. In other examples, the header analyzer 1234 and the body analyzer 1236 may be included in the core 1222 as stand-alone elements.

In some examples, the header analyzer 1234 may process event headers, while the body analyzer analyzes event bodies or payloads, enabling deep analysis and configurable analysis pathways. In some examples, analysis results may be generated using signature methods generative AI suggestions, other processing techniques, or any combination thereof, with configurable analysis configurations for users or administrators.

In some examples, the log analyzer 1238 may convert raw log information (e.g., retrieved or received from the logging platform 1284) into structure data (e.g., JSON data) for further processing, such as event correlation processing.

In some examples, the sandbox analyzer 1240 may verify, analyze, or validate a configuration 1288 before it is transmitted to the WAFs 1266 for implementation. For example, the sandbox analyzer 1240 may include a sandbox environment with a test implementation of a WAF to which the configuration 1288 may be applied. The test implementation may be analyzed to detect errors or misconfigurations which may be corrected before the configuration 1288 is transmitted to the configuration agent 1268 by the configuration controller 1262.

In some examples, the mitigation controller 1242 may perform one or more actions in situations in which a DDoS attack is happening or is suspected to be happening to mitigate the attack or the effects thereof. For example, the mitigation controller 1242 may generate configurations (e.g., the configuration 1288), policies, signatures, or other information (e.g., based on analyzed events, such as the DDoS events 1278 or records thereof, or logs, such as the logs 1290.

In some examples, the risk assessor 1244 may utilize multiple parameters, including DDoS event 1278 processing, consolidated JSON log data (e.g., the logs 1290), and information from the threat intelligence feeds 1208, to automatically generate event risk assessments, determine or initiate mitigation actions, generate or transmit one or more alerts or reports, or any combination thereof. For example, the risk assessor may determine or predict a low risk with an amateur, “script kiddy”-style attack versus a higher risk associated with a state-sponsored attack.

In some examples, the incident predictor 1246 may make predictions of future DDoS events 1278 based on historical event patterns (e.g., historical attacks, attacks on other systems), the logs 1290, information from the threat intelligence feeds 1208, or any combination thereof. The incident predictor 1246 may further utilize Al analysis of any of this information to make the predictions. In some examples, the incident predictor 1246 may store such information in the cache 1220 or a dedicated storage cache. The incident predictor 1246 may further initiate preventive configurations (e.g., via the configuration controller 1262) based on event series, related parameters, the predictions, or any combination thereof.

In some examples, the reverse attack generator 1248 may detect patterns (e.g., independently or through operation of one or more other elements of the system 1200) it generates substantial response delays and payloads transmitted in response to the DDoS attacks, disrupting attacker logic and infrastructure. Further, in some examples, the reverse attack generator 1248 may generate randomized response patterns, confounding default attack strategies on the attacker's end. For example, the reverse attack generator 1248 may generate one or more “heavy” payloads in response to the DDoS events 1278 that may include data that may share one or more characteristics with genuine, authentic responses to queries but actually contains junk or waste data. By transmitting multiple such “heavy” payloads, an attacker's system may become overwhelmed itself, thereby reducing or eliminating the attack by overloading the system or motivating an attacker to attack a different system.

In some examples, the workflow controller 1250 may provide for management of workflows or processing flows (e.g., through multiple generative AI models 1286) enabling configuration of DDoS protection across multiple substrates (e.g., where such flows are managed through the use of the workflow controller 1250). For example, the system 1200 may receive queries associated with DDoS protection that may be spread across multiple substrates by automatically understanding user utterances, mapping intents and information in the queries to one or more operations or information associated with the DDoS protection involving the WAFs 1266 to produce a response to the query that is to be presented to the user.

In some examples, the query processor 1252 may handle received input (e.g., that is received through the communication application 1282 or in another way), such as queries that are to be processed by the generative AI models 1286. In some examples, the system 1200 is a user intent query handling platform that automatically interprets intent of queries (e.g., through the use of the query processor 1252 or one or more other elements of the system 1200). In some examples, the system 1200 may interpret user intent based on multiple generative AI models 1286 based on tuned parameters (e.g., parameters of the generative AI models 1286 or other processing elements that may be tuned by an AI tuner). In some examples, the query processor 1252 may receive or manage operations requests through structured workflows, automatically tailored and configured based on input signatures. The workflows give an easy interface with steps based user interface. In some examples, the query processor 1252 may handle or manage interactive queries from users or administrators, in some cases by passing information to the generative AI models 1286 or other processing systems for processing (e.g., natural language processing, generative AI processing, or other processing).

In some examples, the response controller 1254 may manage thread responses to user or administrator queries and may coordinate with the UX renderer 1260 (e.g., to render one or more elements of a user interface), the data validator 1258 (e.g., to validate user inputs, responses generated by the generative AI models 1286 or other processing models), or any combination thereof.

In some examples, the report controller 1255 may provide precise reporting on statistics and configurations associated with DDoS protection management operations. For example, the report controller 1255 may dynamically generate comprehensive reports associated with the system 1200 (e.g., current or past DDoS attacks, mitigation efforts, configurations, reverse attacks, one or more other operations associated with the system 1200 as described herein, or any combination thereof) offering configurability and deep data drill-downs for users and administrators. In some examples, the report controller 1255 may utilize the generative AI models 1286 to adaptively generate reports to meet dynamic needs, optionally incorporating graphical representations for enhanced clarity (e.g., optionally in concert with the UX renderer 1260).

In some examples, the utilities 1256 may include one or more utilities for DDoS protection management, including user utilities, communication application utilities, generative AI model utilities, internal service utilities, external service utilities, one or more other utilities, or any combination thereof, that may be used to modify parameters, change operation, or otherwise interact with various elements of the system 1200.

In some examples, the data validator 1258 may provide for triaging and troubleshooting of customization options associated with requested actions and user inputs as desired (e.g., through the use of the data validator 1258). In some examples, the system 1200 may perform an analysis of user queries (e.g., to determine one or more issues indicated by the user or detected by the system 1200) and may provide an asynchronous response to the user. In some examples, the system 1200 may provide an indication of an issue, a result of the analysis, and a recommendation for resolving the issue. In some examples, such analysis, response generation, or other operation of the data validator 1258 may be associated with DDoS protection operations.

In some examples, the UX renderer 1260 may be used to generate graphical visualization diagrams based on queries from users, with flexibility for different configurations 1288 or any other aspects of operation of the system 1200 as described herein. For example, a user or administrator may set a configuration (e.g., through the web portal 1206, the web interface controller 1214, or both) for the type of diagrams and their representation. In some examples, such operations may be generated or provided via the UX renderer 1260. Further, in some examples, the system 1200 may improve the automation of query responses based on communication history (e.g., communications through the communication channel over the communications application 1282, optionally made through a communication bot). For example, the system 1200 may offer configurable conversation and workflow modes, either of which may be applied for responding to queries. In some examples, such workflows or processing flows may be customized (e.g., including UX forms and response formats, which may be performed through the use of the UX renderer 1260). Further, in some examples, the system 1200 may allow for processing flows (e.g., “chain of thoughts” processes) that may be formed by connecting the system 1200 to multiple generative AI models 1286 or other processing elements that may be trained or configured (e.g., through the use of the AI bridge 1228, the LLM controller 1230, one or more other elements of the system 1200, or any combination thereof). In some examples, the system 1200 may correct or suggest user queries automatically.

In some examples, the configuration controller 1262 may dynamically configures the WAF deployment 1205 or individual WAFs 1266 thereof, including configuration management, signature management, and tuning parameter management, or other operations. For example, the configuration controller 1262 may be the element that interfaces with the configuration agent 1268 to coordinate transmission of the configuration 1288 to tune or configure the WAFs 1266 based on the configuration 1288.

In some examples, the bridge controller 1264 may manage the bridge 1207 or multiple instances of the bridge 1207 and may coordinate operation between the multiple instances. In some examples, the bridge controller 1264 may receive data from the various bridge 1207 instances and may aggregate, format, or otherwise process the data to provide the data to one or more other elements of the platform 1202 for further processing.

In some examples, the configuration agent 1268 dynamic configurations 1288 used to configure the WAFs 1266. For example, the configuration agent 1268 may receive the configuration 1288 from the platform 1202 (e.g., from the configuration controller 1262) and may configure one or more WAFs 1266 with the configuration 1288.

In some examples, the log agent 1270 may retrieve logs 1290, metadata 1292, or both, from the WAFs 1266. The logs 1290, metadata 1292, or both, may be analyzed (e.g., as a portion of the analysis performed by the platform 1202) to generate a configuration 1288. In some examples, the log agent 1270 may communicate with the platform 1202, the logging platform 1284, one or more other elements of the system 1200, or any combination thereof. For example, the log agent 1270 may communicate with the logging platform 1284 to provide the logging platform 1284 with the logs 1290 associated with one or more WAFs 1266.

In some examples, the bridge 1207 may include or communicate with one or more hooks 1272 associated with one or more WAFs 1266. The hooks 1272 may allow for callback functionality with the WAFs 1266.

In some examples, the events handler 1274 may process raw messages, records, or other information received from the WAFs 1266. In some examples, the messages, records, or other information may be further processed (e.g., via the generative AI models 1286, RAG processing, or other processing), to standardize and structure them.

In some examples, the events unifier 1276 may gather processed messages, records, DDoS events 1278 or records thereof, or any combination thereof and may convert them (e.g., via the generative AI model 1286, RAG processing, or other processing) to a common format (e.g., a JSON format or other structure data format) to provide for uniformity and easier subsequent processing.

In some examples, communications or information passed between the platform 1202, the communications application 1282, the generative AI models 1286, or any combination thereof, may be made through the use of the proxy 1280.

In some examples, the communication application 1282 may provide a platform for a communication bot to communicate with users or administrators to receive queries and to transmit responses (e.g., responses generated by one or more of the elements of the system 1200 as described herein).

In some examples, the logging platform 1284 may process or store one or more logs, such as the logs 1290, associated with operation of the system 1200. In some examples, logs or other records may be analyzed via the logging platform 1284 to provide insights into the operation of the system 1200.

In some examples, the generative AI model 1286 may perform analyses of information, generate responses to queries, determine one or more actions to be performed, or any combination thereof, as described herein.

In some examples, training data associated with the generative AI models 1286 may be stored in an external storage, local storage, the cache 1220, one or more other storage locations, or any combination thereof.

In some examples, the configuration 1288 may be or may include one or more JavaScript Object Notation (JSON) configurations, other structured data, or non-structured data. In some examples, the configurations 1288 or one or more aspects thereof may be stored using version control services, to carefully track and, if appropriate, rollback or undo changes made to configurations.

In some examples, the system 1200 may provide a centralized dashboard and monitoring of the DDoS protection management or operations, such as through the use of an administrator command line interface (CLI), the web portal 1206, or one or more other interfaces. For example, the 1200 may provide for effective management and monitoring, such as through the use of centralized dashboards). Such dashboards may provide insights into performance, query resolution metrics, and system health across all operational domains. Administrators may configure settings, manage user access, and monitor activity of the system 1200 through such dashboards. Real-time alerts and notifications enable prompt action in response to any issues or anomalies, ensuring uninterrupted service delivery and exceptional user experience.

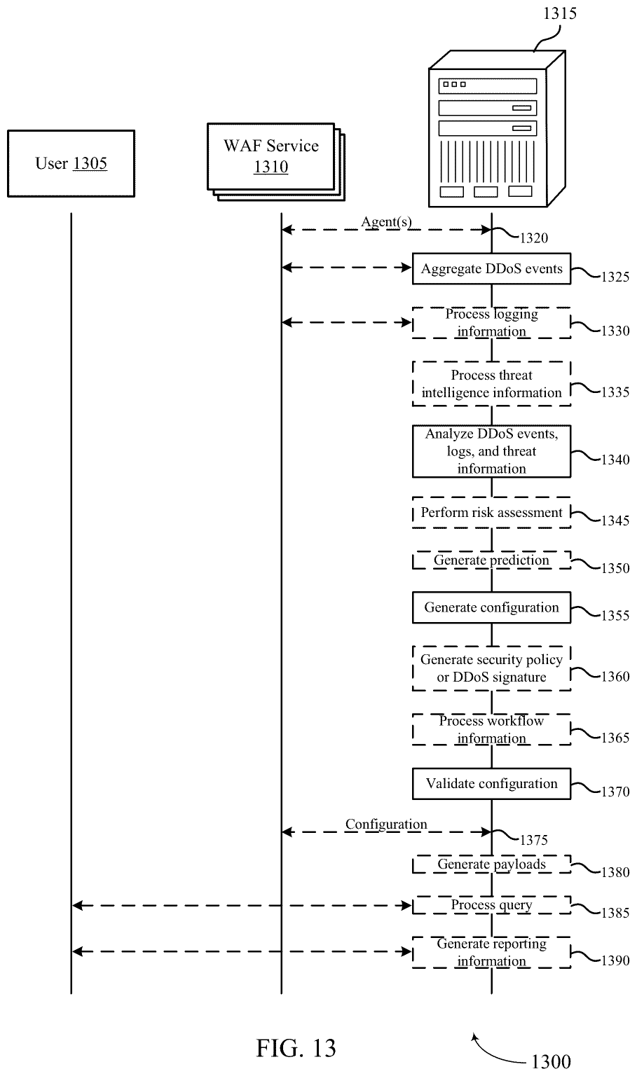

FIG. 13 shows an example of a process flow 1300 that supports distributed denial of service protection management in accordance with aspects of the present disclosure.

The process flow 1300 may implement various aspects of the present disclosure described herein. The elements described in the process flow 1300 (e.g., application server 1315, WAF service(s) 1310, and user/administrator 1305) may be examples of similarly named elements described herein.

In the following description of the process flow 1300, the operations between the various entities or elements may be performed in different orders or at different times. Some operations may also be left out of the process flow 1300, or other operations may be added. Although the various entities or elements are shown performing the operations of the process flow 1300, some aspects of some operations may also be performed by other entities or elements of the process flow 1300 or by entities or elements that are not depicted in the process flow, or any combination thereof.

At 1320, the application server 1315 may deploy a configuration agent and a logging agent that are associated with the one or more WAF services 1310.

At 1325, the application server 1315 may aggregate, from a WAF bridge service that interfaces with one or more WAF services 1310, one or more distributed denial of service (DDoS) event records associated with one or more DDoS events, the one or more DDoS event records converted into a common format via generative artificial intelligence (AI) model processing.

At 1330, the application server 1315 may convert the logging information into a structured format. The application server 1315 may transmit the converted logging information to a generative AI model. The application server 1315 may receive an output of the generative AI model that indicates the one or more characteristics, the output based on the converted logging information.

At 1335, the application server 1315 may receive one or more threat intelligence feed records via the threat intelligence feed.

At 1340, the application server 1315 may analyze the one or more DDoS event records via a first sub-analysis of one or more headers of the one or more DDoS event records and one or more payloads of the one or more DDoS event records, a second sub-analysis of logging information received from the one or more WAF services 1310, and a third sub-analysis of a threat intelligence feed to determine one or more characteristics of the one or more DDoS events.

In some examples, to perform the first sub-analysis, the application server 1315 may transmit the one or more headers, the one or more payloads, or both, to a generative AI model, receive an output of the generative AI model that indicates the one or more characteristics, the output based on the one or more headers, the one or more payloads, or both. In some examples, the logging information is received from the logging agent. In some examples, the one or more characteristics comprise a quantity of the one or more DDoS events, one or more sources of the one or more DDoS events, one or more actions performed during a time period associated with the one or more DDoS events, or any combination thereof.

At 1345, the application server 1315 may perform a risk assessment of the one or more DDoS events based on the one or more DDoS event records, the logging information, information associated with the threat intelligence feed, previous DDoS event information, or any combination thereof. In some examples, the application server 1315 may further determine one or more threat mitigation actions based on the risk assessment and the security configuration is based on the risk assessment, the one or more threat mitigation actions, or any combination thereof.

At 1350, the application server 1315 may generate a prediction of one or more future DDoS events based on the one or more characteristics of the one or more DDoS event records.

At 1355, the application server 1315 may generate, based on the analysis of the one or more DDoS event records, a security configuration for the one or more WAF services 1310 that indicates one or more parameters of the one or more WAF services 1310 to be set based on the one or more characteristics of the one or more DDoS events. In some examples, the security configuration may be based on the prediction. In some examples, the security configuration is based on a generative AI analysis of the one or more threat intelligence feed records. In some examples, to generate the security configuration, the application server 1315 may transmit a prompt to a generative AI model that indicates the one or more characteristics and may include an instruction to generate the security configuration and may further receive an output of the generative AI model that indicates at least a portion of the security configuration.

At 1360, the application server 1315 may generate one or more security policies, one or more DDoS signatures, or any combination thereof based on the one or more DDoS event records, the logging information, or any combination thereof.

At 1365, the application server 1315 may transmit mitigation information to an external orchestration service, the mitigation information that may include one or more elements of the one or more DDoS event records, one or more elements of the analysis of the DDoS event records, one or more mitigation operations performed, or any combination thereof. The application server 1315 may further receive, from the external orchestration service, mitigation workflow information that is based on the mitigation information.

At 1370, the application server 1315 may validate the security configuration in a sandbox environment. For example, the application server 1315 may employ a sandbox analyzer service, such as the sandbox analyzer 1240 described herein, to test and validate the configuration by applying the configuration to a model or test instance of a WAF. The application server 1315 may determine whether the configuration is correctly applied or whether the configuration causes the WAF to operate as intended. If not, the configuration may be modified to remedy such deficiencies or change characteristics or elements of the configuration.

At 1375, the application server 1315 may transmit the security configuration to the one or more WAF services 1310 based on the validation. In some examples, transmitting the security configuration may include transmitting the security configuration to the configuration agent. In some examples, the WAF services 1310 may transmit signaling to the application server 1315 to indicate whether the configuration was successfully applied or not. In some examples, in response to an unsuccessful application, the application server 1315 may retransmit the configuration to the WAF services 1310 and, in some examples, the retransmitted configuration may be a modified configuration (e.g., to promote easier application of the configuration) or may be the same configuration that was sent previously.

At 1380, the application server 1315 may generate, based on the one or more characteristics of the one or more DDoS events, a plurality of payloads that are responsive to the one or more DDoS events and that comprise waste data and transmit the plurality of payloads to one or more sources of the one or more DDoS events in accordance with a randomized transmission pattern.

At 1385, the application server 1315 may receive, via a communication channel of a multi-tenant communication service, a request for information associated with the one or more DDoS events, the security configuration, the validation of the security configuration, the one or more WAF services 1310, the analysis of the one or more DDoS event records, or any combination thereof. The application server 1315 may transmit, to a generative AI model, a prompt that is based on the request. The application server 1315 may receive an output of the generative AI model that indicates the information. The application server 1315 may transmit a response to the request that is based on the output of the generative AI model.

At 1390, the application server 1315 may generate reporting information associated with the one or more DDoS events, the security configuration, the validation of the security configuration, the one or more WAF services 1310, the analysis of the one or more DDoS event records, or any combination thereof and the reporting information is formatted using a generative AI model. For example, in some cases, the application server 1315 may support the use of set alerts that may be transmitted (e.g., to administrators) based on one or more conditions being satisfied. For example, such conditions may include one or more predetermined or selected events associated with DDoS protection schemes, operations of the application server 1315, the WAF services 1310, the user 1305, any operation or event described herein, or any combination thereof. Further, an administrator may customize the triggers or conditions under which an alert may be transmitted.

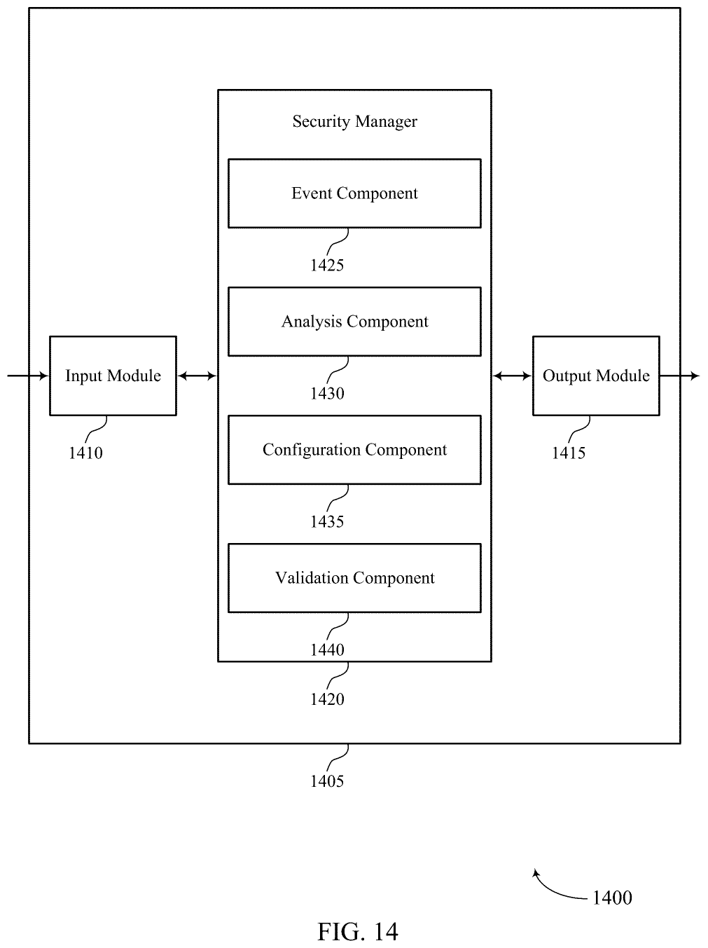

FIG. 14 shows a block diagram 1400 of a device 1405 that supports distributed denial of service protection management in accordance with aspects of the present disclosure. The device 1405 may include an input module 1410, an output module 1415, and a security manager 1420. The device 1405, or one or more components of the device 1405 (e.g., the input module 1410, the output module 1415, the security manager 1420), may include at least one processor, which may be coupled with at least one memory, to support the described techniques. Each of these components may be in communication with one another (e.g., via one or more buses).

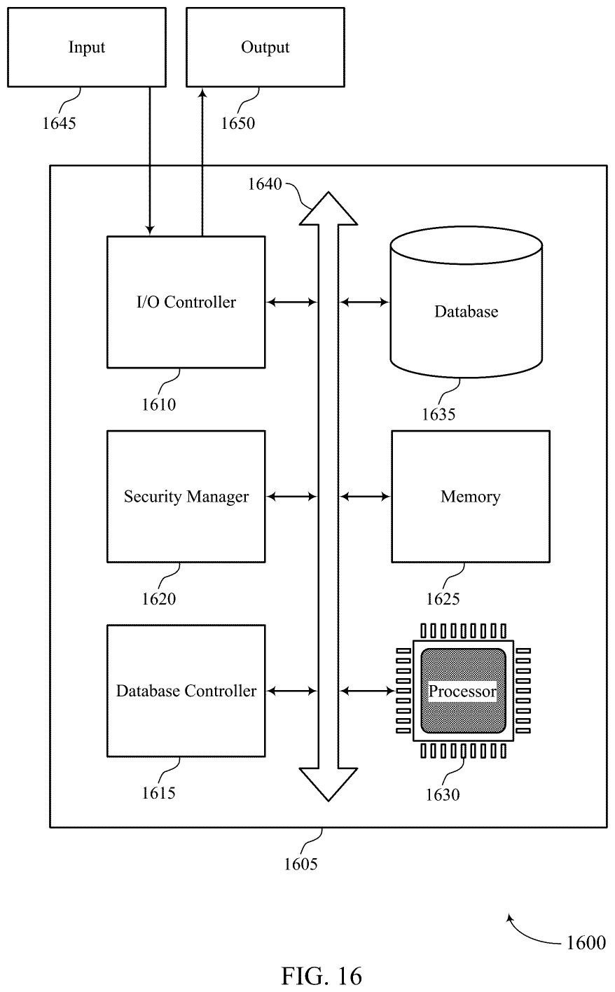

The input module 1410 may manage input signals for the device 1405. For example, the input module 1410 may identify input signals based on an interaction with a modem, a keyboard, a mouse, a touchscreen, or a similar device. These input signals may be associated with user input or processing at other components or devices. In some cases, the input module 1410 may utilize an operating system such as iOS®, ANDROID®, MS-DOS®, MS-WINDOWS®, OS/2®, UNIX®, LINUX®, or another known operating system to handle input signals. The input module 1410 may send aspects of these input signals to other components of the device 1405 for processing. For example, the input module 1410 may transmit input signals to the security manager 1420 to support distributed denial of service protection management. In some cases, the input module 1410 may be a component of an input/output (I/O) controller 1610 as described with reference to FIG. 16.

The output module 1415 may manage output signals for the device 1405. For example, the output module 1415 may receive signals from other components of the device 1405, such as the security manager 1420, and may transmit these signals to other components or devices. In some examples, the output module 1415 may transmit output signals for display in a user interface, for storage in a database or data store, for further processing at a server or server cluster, or for any other processes at any number of devices or systems. In some cases, the output module 1415 may be a component of an I/O controller 1610 as described with reference to FIG. 16.

For example, the security manager 1420 may include an event component 1425, an analysis component 1430, a configuration component 1435, a validation component 1440, or any combination thereof. In some examples, the security manager 1420, or various components thereof, may be configured to perform various operations (e.g., receiving, monitoring, transmitting) using or otherwise in cooperation with the input module 1410, the output module 1415, or both. For example, the security manager 1420 may receive information from the input module 1410, send information to the output module 1415, or be integrated in combination with the input module 1410, the output module 1415, or both to receive information, transmit information, or perform various other operations as described herein.

The security manager 1420 may support data processing in accordance with examples as disclosed herein. The event component 1425 may be configured to support aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing. The analysis component 1430 may be configured to support analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events. The configuration component 1435 may be configured to support generating, based on the analysis of the one or more DDoS event records, a security configuration for the one or more WAF services that indicates one or more parameters of the one or more WAF services to be set based on the one or more characteristics of the one or more DDoS events. The validation component 1440 may be configured to support validating the security configuration in a sandbox environment. The configuration component 1435 may be configured to support transmitting the security configuration to the one or more WAF services based on the validation.

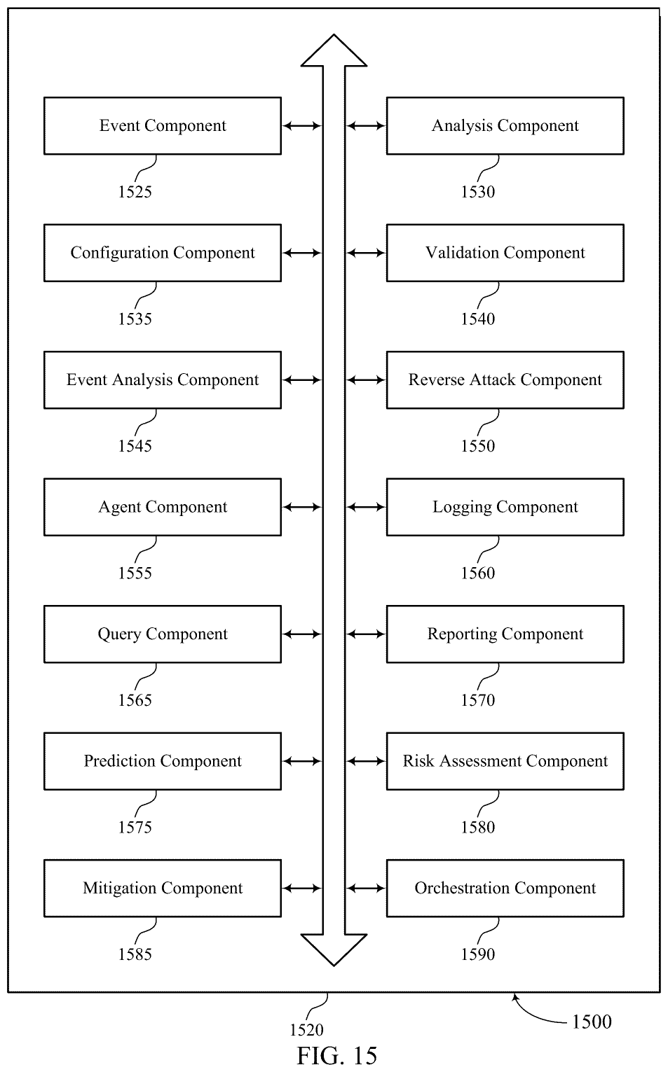

FIG. 15 shows a block diagram 1500 of a security manager 1520 that supports distributed denial of service protection management in accordance with aspects of the present disclosure. The security manager 1520 may be an example of aspects of a security manager or a security manager 1420, or both, as described herein. The security manager 1520, or various components thereof, may be an example of means for performing various aspects of distributed denial of service protection management as described herein. For example, the security manager 1520 may include an event component 1525, an analysis component 1530, a configuration component 1535, a validation component 1540, an event analysis component 1545, a reverse attack component 1550, an agent component 1555, a logging component 1560, a query component 1565, a reporting component 1570, a prediction component 1575, a risk assessment component 1580, a mitigation component 1585, an orchestration component 1590, or any combination thereof. Each of these components, or components of subcomponents thereof (e.g., one or more processors, one or more memories), may communicate, directly or indirectly, with one another (e.g., via one or more buses).

The security manager 1520 may support data processing in accordance with examples as disclosed herein. The event component 1525 may be configured to support aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing. The analysis component 1530 may be configured to support analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events. The configuration component 1535 may be configured to support generating, based on the analysis of the one or more DDoS event records, a security configuration for the one or more WAF services that indicates one or more parameters of the one or more WAF services to be set based on the one or more characteristics of the one or more DDoS events. The validation component 1540 may be configured to support validating the security configuration in a sandbox environment. In some examples, the configuration component 1535 may be configured to support transmitting the security configuration to the one or more WAF services based on the validation.

In some examples, to support performing the first sub-analysis, the event analysis component 1545 may be configured to support transmitting the one or more headers, the one or more payloads, or both, to a generative AI model. In some examples, to support performing the first sub-analysis, the event analysis component 1545 may be configured to support receiving an output of the generative AI model that indicates the one or more characteristics, the output based on the one or more headers, the one or more payloads, or both.

In some examples, the reverse attack component 1550 may be configured to support generating, based on the one or more characteristics of the one or more DDoS events, a set of multiple payloads that are responsive to the one or more DDoS events and that include waste data. In some examples, the reverse attack component 1550 may be configured to support transmitting the set of multiple payloads to one or more sources of the one or more DDoS events in accordance with a randomized transmission pattern.

In some examples, the agent component 1555 may be configured to support deploying a configuration agent and a logging agent that are associated with the one or more WAF services. In some examples, the agent component 1555 may be configured to support where transmitting the security configuration includes transmitting the security configuration to the configuration agent. In some examples, the logging component 1560 may be configured to support where the logging information is received from the logging agent.

In some examples, the logging component 1560 may be configured to support converting the logging information into a structured format. In some examples, the logging component 1560 may be configured to support transmitting the converted logging information to a generative AI model. In some examples, the logging component 1560 may be configured to support receiving an output of the generative AI model that indicates the one or more characteristics, the output based on the converted logging information.

In some examples, the query component 1565 may be configured to support receiving, via a communication channel of a multi-tenant communication service, a request for information associated with the one or more DDoS events, the security configuration, the validation of the security configuration, the one or more WAF services, the analysis of the one or more DDoS event records, or any combination thereof. In some examples, the query component 1565 may be configured to support transmitting, to a generative AI model, a prompt that is based on the request. In some examples, the query component 1565 may be configured to support receiving an output of the generative AI model that indicates the information. In some examples, the query component 1565 may be configured to support transmitting a response to the request that is based on the output of the generative AI model.

In some examples, the reporting component 1570 may be configured to support generating reporting information associated with the one or more DDoS events, the security configuration, the validation of the security configuration, the one or more WAF services, the analysis of the one or more DDoS event records, or any combination thereof, where the reporting information is formatted using a generative AI model.

In some examples, the prediction component 1575 may be configured to support generating a prediction of one or more future DDoS events based on the one or more characteristics of the one or more DDoS event records. In some examples, the configuration component 1535 may be configured to support where the security configuration is based on the prediction.

In some examples, to support performing the third sub-analysis, the analysis component 1530 may be configured to support receiving one or more threat intelligence feed records via the threat intelligence feed. In some examples, to support performing the third sub-analysis, the analysis component 1530 may be configured to support where the security configuration is based on a generative AI analysis of the one or more threat intelligence feed records.

In some examples, to support generating the security configuration, the configuration component 1535 may be configured to support transmitting a prompt to a generative AI model that indicates the one or more characteristics and includes an instruction to generate the security configuration. In some examples, to support generating the security configuration, the configuration component 1535 may be configured to support receiving an output of the generative AI model that indicates at least a portion of the security configuration.

In some examples, the one or more characteristics include a quantity of the one or more DDoS events, one or more sources of the one or more DDoS events, one or more actions performed during a time period associated with the one or more DDoS events, or any combination thereof.

In some examples, the risk assessment component 1580 may be configured to support performing a risk assessment of the one or more DDoS events based on the one or more DDoS event records, the logging information, information associated with the threat intelligence feed, previous DDoS event information, or any combination thereof. In some examples, the risk assessment component 1580 may be configured to support determining one or more threat mitigation actions based on the risk assessment, where the security configuration is based on the risk assessment, the one or more threat mitigation actions, or any combination thereof.

In some examples, the mitigation component 1585 may be configured to support generating one or more security policies, one or more DDoS signatures, or any combination thereof based on the one or more DDoS event records, the logging information, or any combination thereof.

In some examples, the orchestration component 1590 may be configured to support transmitting mitigation information to an external orchestration service, the mitigation information including one or more elements of the one or more DDoS event records, one or more elements of the analysis of the DDoS event records, one or more mitigation operations performed, or any combination thereof. In some examples, the orchestration component 1590 may be configured to support receiving, from the external orchestration service, mitigation workflow information that is based on the mitigation information.

FIG. 16 shows a diagram of a system 1600 including a device 1605 that supports distributed denial of service protection management in accordance with aspects of the present disclosure. The device 1605 may be an example of or include components of a device 1405 as described herein. The device 1605 may include components for bi-directional data communications including components for transmitting and receiving communications, such as a security manager 1620, an I/O controller, such as an I/O controller 1610, a database controller 1615, at least one memory 1625, at least one processor 1630, and a database 1635. These components may be in electronic communication or otherwise coupled (e.g., operatively, communicatively, functionally, electronically, electrically) via one or more buses (e.g., a bus 1640).

The I/O controller 1610 may manage input signals 1645 and output signals 1650 for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. In other cases, the I/O controller 1610 may represent or interact with a modem, a keyboard, a mouse, a touchscreen, or a similar device. In some cases, the I/O controller 1610 may be implemented as part of a processor 1630. In some examples, a user may interact with the device 1605 via the I/O controller 1610 or via hardware components controlled by the I/O controller 1610.

The database controller 1615 may manage data storage and processing in a database 1635. In some cases, a user may interact with the database controller 1615. In other cases, the database controller 1615 may operate automatically without user interaction. The database 1635 may be an example of a single database, a distributed database, multiple distributed databases, a data store, a data lake, or an emergency backup database.

Memory 1625 may include random-access memory (RAM) and read-only memory (ROM). The memory 1625 may store computer-readable, computer-executable software including instructions that, when executed, cause at least one processor 1630 to perform various functions described herein. In some cases, the memory 1625 may contain, among other things, a basic I/O system (BIOS) which may control basic hardware or software operation such as the interaction with peripheral components or devices. The memory 1625 may be an example of a single memory or multiple memories. For example, the device 1605 may include one or more memories 1625.

The processor 1630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1630 may be configured to operate a memory array using a memory controller. In other cases, a memory controller may be integrated into the processor 1630. The processor 1630 may be configured to execute computer-readable instructions stored in at least one memory 1625 to perform various functions (e.g., functions or tasks supporting distributed denial of service protection management). The processor 1630 may be an example of a single processor or multiple processors. For example, the device 1605 may include one or more processors 1630.

The security manager 1620 may support data processing in accordance with examples as disclosed herein. For example, the security manager 1620 may be configured to support aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing. The security manager 1620 may be configured to support analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events. The security manager 1620 may be configured to support generating, based on the analysis of the one or more DDoS event records, a security configuration for the one or more WAF services that indicates one or more parameters of the one or more WAF services to be set based on the one or more characteristics of the one or more DDoS events. The security manager 1620 may be configured to support validating the security configuration in a sandbox environment. The security manager 1620 may be configured to support transmitting the security configuration to the one or more WAF services based on the validation.

By including or configuring the security manager 1620 in accordance with examples as described herein, the device 1605 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

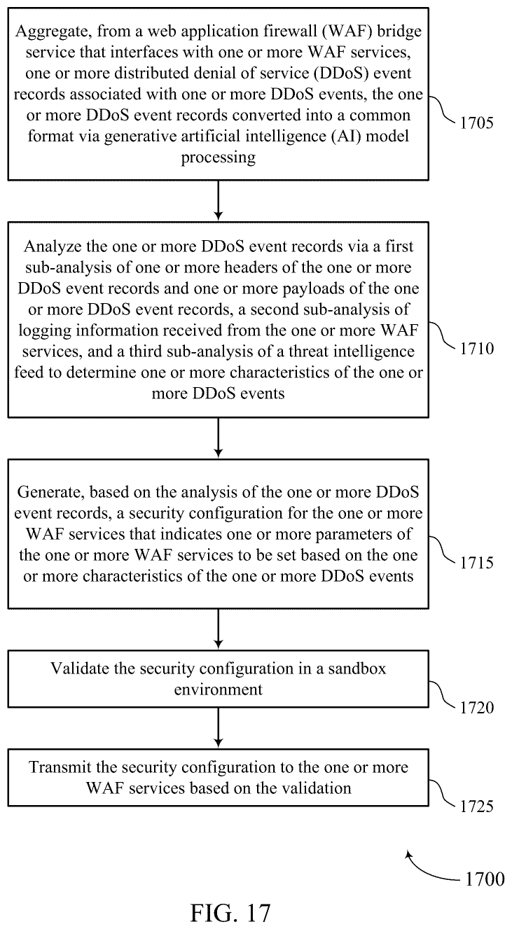

FIG. 17 shows a flowchart illustrating a method 1700 that supports distributed denial of service protection management in accordance with aspects of the present disclosure. The operations of the method 1700 may be implemented by an application server or its components as described herein. For example, the operations of the method 1700 may be performed by an application server as described with reference to FIGS. 1 through 16. In some examples, an application server may execute a set of instructions to control the functional elements of the application server to perform the described functions. Additionally, or alternatively, the application server may perform aspects of the described functions using special-purpose hardware.

At 1705, the method may include aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing. The operations of 1705 may be performed in accordance with examples as disclosed herein. In some examples, aspects of the operations of 1705 may be performed by an event component 1525 as described with reference to FIG. 15.

At 1710, the method may include analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events. The operations of 1710 may be performed in accordance with examples as disclosed herein. In some examples, aspects of the operations of 1710 may be performed by an analysis component 1530 as described with reference to FIG. 15.

At 1715, the method may include generating, based on the analysis of the one or more DDoS event records, a security configuration for the one or more WAF services that indicates one or more parameters of the one or more WAF services to be set based on the one or more characteristics of the one or more DDoS events. The operations of 1715 may be performed in accordance with examples as disclosed herein. In some examples, aspects of the operations of 1715 may be performed by a configuration component 1535 as described with reference to FIG. 15.

At 1720, the method may include validating the security configuration in a sandbox environment. The operations of 1720 may be performed in accordance with examples as disclosed herein. In some examples, aspects of the operations of 1720 may be performed by a validation component 1540 as described with reference to FIG. 15.

At 1725, the method may include transmitting the security configuration to the one or more WAF services based on the validation. The operations of 1725 may be performed in accordance with examples as disclosed herein. In some examples, aspects of the operations of 1725 may be performed by a configuration component 1535 as described with reference to FIG. 15.

A method for data processing by an apparatus is described. The method may include aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing, analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events, generating, based on the analysis of the one or more DDoS event records, a security configuration for the one or more WAF services that indicates one or more parameters of the one or more WAF services to be set based on the one or more characteristics of the one or more DDoS events, validating the security configuration in a sandbox environment, and transmitting the security configuration to the one or more WAF services based on the validation.

An apparatus for data processing is described. The apparatus may include one or more memories storing processor executable code, and one or more processors coupled with the one or more memories. The one or more processors may individually or collectively be operable to execute the code to cause the apparatus to aggregate, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing, analyze the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events, generate, based on the analysis of the one or more DDoS event records, a security configuration for the one or more WAF services that indicates one or more parameters of the one or more WAF services to be set based on the one or more characteristics of the one or more DDoS events, validate the security configuration in a sandbox environment, and transmit the security configuration to the one or more WAF services based on the validation.

Another apparatus for data processing is described. The apparatus may include means for aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing, means for analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events, means for generating, based on the analysis of the one or more DDoS event records, a security configuration for the one or more WAF services that indicates one or more parameters of the one or more WAF services to be set based on the one or more characteristics of the one or more DDoS events, means for validating the security configuration in a sandbox environment, and means for transmitting the security configuration to the one or more WAF services based on the validation.

A non-transitory computer-readable medium storing code for data processing is described. The code may include instructions executable by one or more processors to aggregate, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing, analyze the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events, generate, based on the analysis of the one or more DDoS event records, a security configuration for the one or more WAF services that indicates one or more parameters of the one or more WAF services to be set based on the one or more characteristics of the one or more DDoS events, validate the security configuration in a sandbox environment, and transmit the security configuration to the one or more WAF services based on the validation.

In some examples of the method, apparatus, and non-transitory computer-readable medium described herein, performing the first sub-analysis may include operations, features, means, or instructions for transmitting the one or more headers, the one or more payloads, or both, to a generative AI model and receiving an output of the generative AI model that indicates the one or more characteristics, the output based on the one or more headers, the one or more payloads, or both.

Some examples of the method, apparatus, and non-transitory computer-readable medium described herein may further include operations, features, means, or instructions for generating, based on the one or more characteristics of the one or more DDoS events, a set of multiple payloads that may be responsive to the one or more DDoS events and that include waste data and transmitting the set of multiple payloads to one or more sources of the one or more DDoS events in accordance with a randomized transmission pattern.

Some examples of the method, apparatus, and non-transitory computer-readable medium described herein may further include operations, features, means, or instructions for deploying a configuration agent and a logging agent that may be associated with the one or more WAF services, where transmitting the security configuration includes transmitting the security configuration to the configuration agent, and where the logging information may be received from the logging agent.

Some examples of the method, apparatus, and non-transitory computer-readable medium described herein may further include operations, features, means, or instructions for converting the logging information into a structured format, transmitting the converted logging information to a generative AI model, and receiving an output of the generative AI model that indicates the one or more characteristics, the output based on the converted logging information.

Some examples of the method, apparatus, and non-transitory computer-readable medium described herein may further include operations, features, means, or instructions for receiving, via a communication channel of a multi-tenant communication service, a request for information associated with the one or more DDoS events, the security configuration, the validation of the security configuration, the one or more WAF services, the analysis of the one or more DDoS event records, or any combination thereof, transmitting, to a generative AI model, a prompt that may be based on the request, receiving an output of the generative AI model that indicates the information, and transmitting a response to the request that may be based on the output of the generative AI model.

Some examples of the method, apparatus, and non-transitory computer-readable medium described herein may further include operations, features, means, or instructions for generating reporting information associated with the one or more DDoS events, the security configuration, the validation of the security configuration, the one or more WAF services, the analysis of the one or more DDoS event records, or any combination thereof, where the reporting information may be formatted using a generative AI model.

Some examples of the method, apparatus, and non-transitory computer-readable medium described herein may further include operations, features, means, or instructions for generating a prediction of one or more future DDoS events based on the one or more characteristics of the one or more DDoS event records and where the security configuration may be based on the prediction.

In some examples of the method, apparatus, and non-transitory computer-readable medium described herein, performing the third sub-analysis may include operations, features, means, or instructions for receiving one or more threat intelligence feed records via the threat intelligence feed and where the security configuration may be based on a generative AI analysis of the one or more threat intelligence feed records.

In some examples of the method, apparatus, and non-transitory computer-readable medium described herein, generating the security configuration may include operations, features, means, or instructions for transmitting a prompt to a generative AI model that indicates the one or more characteristics and includes an instruction to generate the security configuration and receiving an output of the generative AI model that indicates at least a portion of the security configuration.

In some examples of the method, apparatus, and non-transitory computer-readable medium described herein, the one or more characteristics include a quantity of the one or more DDoS events, one or more sources of the one or more DDoS events, one or more actions performed during a time period associated with the one or more DDoS events, or any combination thereof.

Some examples of the method, apparatus, and non-transitory computer-readable medium described herein may further include operations, features, means, or instructions for performing a risk assessment of the one or more DDoS events based on the one or more DDoS event records, the logging information, information associated with the threat intelligence feed, previous DDoS event information, or any combination thereof and determining one or more threat mitigation actions based on the risk assessment, where the security configuration may be based on the risk assessment, the one or more threat mitigation actions, or any combination thereof.

Some examples of the method, apparatus, and non-transitory computer-readable medium described herein may further include operations, features, means, or instructions for generating one or more security policies, one or more DDoS signatures, or any combination thereof based on the one or more DDoS event records, the logging information, or any combination thereof.

Some examples of the method, apparatus, and non-transitory computer-readable medium described herein may further include operations, features, means, or instructions for transmitting mitigation information to an external orchestration service, the mitigation information including one or more elements of the one or more DDoS event records, one or more elements of the analysis of the DDoS event records, one or more mitigation operations performed, or any combination thereof and receiving, from the external orchestration service, mitigation workflow information that may be based on the mitigation information.

The following provides an overview of aspects of the present disclosure:

Aspect 1: A method for data processing, comprising: aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing; analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events; generating, based at least in part on the analysis of the one or more DDoS event records, a security configuration for the one or more WAF services that indicates one or more parameters of the one or more WAF services to be set based at least in part on the one or more characteristics of the one or more DDoS events; validating the security configuration in a sandbox environment; and transmitting the security configuration to the one or more WAF services based at least in part on the validation.

Aspect 2: The method of aspect 1, wherein performing the first sub-analysis comprises: transmitting the one or more headers, the one or more payloads, or both, to a generative AI model; and receiving an output of the generative AI model that indicates the one or more characteristics, the output based at least in part on the one or more headers, the one or more payloads, or both.

Aspect 3: The method of any of aspects 1 through 2, further comprising: generating, based at least in part on the one or more characteristics of the one or more DDoS events, a plurality of payloads that are responsive to the one or more DDoS events and that comprise waste data; and transmitting the plurality of payloads to one or more sources of the one or more DDoS events in accordance with a randomized transmission pattern.

Aspect 4: The method of any of aspects 1 through 3, further comprising: deploying a configuration agent and a logging agent that are associated with the one or more WAF services; wherein transmitting the security configuration comprises transmitting the security configuration to the configuration agent; and wherein the logging information is received from the logging agent.

Aspect 5: The method of any of aspects 1 through 4, further comprising: converting the logging information into a structured format; transmitting the converted logging information to a generative AI model; and receiving an output of the generative AI model that indicates the one or more characteristics, the output based at least in part on the converted logging information.

Aspect 6: The method of any of aspects 1 through 5, further comprising: receiving, via a communication channel of a multi-tenant communication service, a request for information associated with the one or more DDoS events, the security configuration, the validation of the security configuration, the one or more WAF services, the analysis of the one or more DDoS event records, or any combination thereof; transmitting, to a generative AI model, a prompt that is based at least in part on the request; receiving an output of the generative AI model that indicates the information; and transmitting a response to the request that is based at least in part on the output of the generative AI model.

Aspect 7: The method of any of aspects 1 through 6, further comprising: generating reporting information associated with the one or more DDoS events, the security configuration, the validation of the security configuration, the one or more WAF services, the analysis of the one or more DDoS event records, or any combination thereof, wherein the reporting information is formatted using a generative AI model.

Aspect 8: The method of any of aspects 1 through 7, further comprising: generating a prediction of one or more future DDoS events based at least in part on the one or more characteristics of the one or more DDoS event records; wherein the security configuration is based at least in part on the prediction.

Aspect 9: The method of any of aspects 1 through 8, wherein performing the third sub-analysis comprises: receiving one or more threat intelligence feed records via the threat intelligence feed; wherein the security configuration is based at least in part on a generative AI analysis of the one or more threat intelligence feed records.

Aspect 10: The method of any of aspects 1 through 9, wherein generating the security configuration comprises: transmitting a prompt to a generative AI model that indicates the one or more characteristics and comprises an instruction to generate the security configuration; and receiving an output of the generative AI model that indicates at least a portion of the security configuration.

Aspect 11: The method of any of aspects 1 through 10, wherein the one or more characteristics comprise a quantity of the one or more DDoS events, one or more sources of the one or more DDoS events, one or more actions performed during a time period associated with the one or more DDoS events, or any combination thereof.

Aspect 12: The method of any of aspects 1 through 11, further comprising: performing a risk assessment of the one or more DDoS events based at least in part on the one or more DDoS event records, the logging information, information associated with the threat intelligence feed, previous DDoS event information, or any combination thereof; and determining one or more threat mitigation actions based at least in part on the risk assessment, wherein the security configuration is based at least in part on the risk assessment, the one or more threat mitigation actions, or any combination thereof.

Aspect 13: The method of any of aspects 1 through 12, further comprising: generating one or more security policies, one or more DDoS signatures, or any combination thereof based at least in part on the one or more DDoS event records, the logging information, or any combination thereof.

Aspect 14: The method of any of aspects 1 through 13, further comprising: transmitting mitigation information to an external orchestration service, the mitigation information comprising one or more elements of the one or more DDoS event records, one or more elements of the analysis of the DDoS event records, one or more mitigation operations performed, or any combination thereof; and receiving, from the external orchestration service, mitigation workflow information that is based at least in part on the mitigation information.

Aspect 15: An apparatus for data processing, comprising one or more memories storing processor-executable code, and one or more processors coupled with the one or more memories and individually or collectively operable to execute the code to cause the apparatus to perform a method of any of aspects 1 through 14.

Aspect 16: An apparatus for data processing, comprising at least one means for performing a method of any of aspects 1 through 14.

Aspect 17: A non-transitory computer-readable medium storing code for data processing, the code comprising instructions executable by one or more processors to perform a method of any of aspects 1 through 14.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
aggregating, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing;
analyzing the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events;
generating, based at least in part on analyzing the one or more DDoS event records, a security configuration for the one or more WAF services that indicates one or more parameters of the one or more WAF services to be set based at least in part on the one or more characteristics of the one or more DDoS events;
validating the security configuration in a sandbox environment; and
transmitting the security configuration to the one or more WAF services based at least in part on the validation.

2. The method of claim 1, wherein performing the first sub-analysis comprises:
transmitting the one or more headers, the one or more payloads, or both, to a generative AI model; and
receiving an output of the generative AI model that indicates the one or more characteristics, the output based at least in part on the one or more headers, the one or more payloads, or both.

3. The method of claim 1, further comprising:
generating, based at least in part on the one or more characteristics of the one or more DDoS events, a plurality of payloads that are responsive to the one or more DDoS events and that comprise waste data; and
transmitting the plurality of payloads to one or more sources of the one or more DDoS events in accordance with a randomized transmission pattern.

4. The method of claim 1, further comprising:
deploying a configuration agent and a logging agent that are associated with the one or more WAF services, wherein transmitting the security configuration comprises transmitting the security configuration to the configuration agent, and wherein the logging information is received from the logging agent.

5. The method of claim 1, further comprising:
converting the logging information into a structured format;
transmitting the converted logging information to a generative AI model; and
receiving an output of the generative AI model that indicates the one or more characteristics, the output based at least in part on the converted logging information.

6. The method of claim 1, further comprising:
receiving, via a communication channel of a multi-tenant communication service, a request for information associated with the one or more DDoS events, the security configuration, the validation of the security configuration, the one or more WAF services, an analysis of the one or more DDoS event records, or any combination thereof;
transmitting, to a generative AI model, a prompt that is based at least in part on the request;
receiving an output of the generative AI model that indicates the information; and
transmitting a response to the request that is based at least in part on the output of the generative AI model.

7. The method of claim 1, further comprising:
generating reporting information associated with the one or more DDoS events, the security configuration, the validation of the security configuration, the one or more WAF services, an analysis of the one or more DDoS event records, or any combination thereof, wherein the reporting information is formatted using a generative AI model.

8. The method of claim 1, further comprising:
generating a prediction of one or more future DDoS events based at least in part on the one or more characteristics of the one or more DDoS event records;
wherein the security configuration is based at least in part on the prediction.

9. The method of claim 1, wherein performing the third sub-analysis comprises:
receiving one or more threat intelligence feed records via the threat intelligence feed;
wherein the security configuration is based at least in part on a generative AI analysis of the one or more threat intelligence feed records.

10. The method of claim 1, wherein generating the security configuration comprises:
transmitting a prompt to a generative AI model that indicates the one or more characteristics and comprises an instruction to generate the security configuration; and
receiving an output of the generative AI model that indicates at least a portion of the security configuration.

11. The method of claim 1, wherein the one or more characteristics comprise a quantity of the one or more DDoS events, one or more sources of the one or more DDoS events, one or more actions performed during a time period associated with the one or more DDoS events, or any combination thereof.

12. The method of claim 1, further comprising:
performing a risk assessment of the one or more DDoS events based at least in part on the one or more DDoS event records, the logging information, information associated with the threat intelligence feed, previous DDoS event information, or any combination thereof; and
determining one or more threat mitigation actions based at least in part on the risk assessment, wherein the security configuration is based at least in part on the risk assessment, the one or more threat mitigation actions, or any combination thereof.

13. The method of claim 1, further comprising:
generating one or more security policies, one or more DDoS signatures, or any combination thereof based at least in part on the one or more DDoS event records, the logging information, or any combination thereof.

14. The method of claim 1, further comprising:
transmitting mitigation information to an external orchestration service, the mitigation information comprising one or more elements of the one or more DDoS event records, one or more elements of an analysis of the DDoS event records, one or more mitigation operations performed, or any combination thereof; and
receiving, from the external orchestration service, mitigation workflow information that is based at least in part on the mitigation information.

15. An apparatus for data processing, comprising:
one or more memories storing processor-executable code; and
one or more processors coupled with the one or more memories and individually or collectively operable to execute the code to cause the apparatus to:
aggregate, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing;
analyze the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events;
generate, based at least in part on analyzing the one or more DDoS event records, a security configuration for the one or more WAF services that indicates one or more parameters of the one or more WAF services to be set based at least in part on the one or more characteristics of the one or more DDoS events;
validate the security configuration in a sandbox environment; and
transmit the security configuration to the one or more WAF services based at least in part on the validation.

16. The apparatus of claim 15, wherein, to perform the first sub-analysis, the one or more processors are individually or collectively operable to execute the code to cause the apparatus to:
transmit the one or more headers, the one or more payloads, or both, to a generative AI model; and
receive an output of the generative AI model that indicates the one or more characteristics, the output based at least in part on the one or more headers, the one or more payloads, or both.

17. The apparatus of claim 15, wherein the one or more processors are individually or collectively further operable to execute the code to cause the apparatus to:
generate, based at least in part on the one or more characteristics of the one or more DDoS events, a plurality of payloads that are responsive to the one or more DDoS events and that comprise waste data; and
transmit the plurality of payloads to one or more sources of the one or more DDoS events in accordance with a randomized transmission pattern.

18. The apparatus of claim 15, wherein the one or more processors are individually or collectively further operable to execute the code to cause the apparatus to:
deploy a configuration agent and a logging agent that are associated with the one or more WAF services, wherein transmitting the security configuration comprises transmitting the security configuration to the configuration agent, and wherein the logging information is received from the logging agent.

19. The apparatus of claim 15, wherein the one or more processors are individually or collectively further operable to execute the code to cause the apparatus to:
convert the logging information into a structured format;
transmit the converted logging information to a generative AI model; and
receive an output of the generative AI model that indicates the one or more characteristics, the output based at least in part on the converted logging information.

20. A non-transitory computer-readable medium storing code for data processing, the code comprising instructions executable by one or more processors to:
aggregate, from a web application firewall (WAF) bridge service that interfaces with one or more WAF services, one or more distributed denial of service (DDoS) event records associated with one or more DDoS events, the one or more DDoS event records converted into a common format via generative artificial intelligence (AI) model processing;
analyze the one or more DDoS event records via a first sub-analysis of one or more headers of the one or more DDoS event records and one or more payloads of the one or more DDoS event records, a second sub-analysis of logging information received from the one or more WAF services, and a third sub-analysis of a threat intelligence feed to determine one or more characteristics of the one or more DDoS events;
generate, based at least in part on analyzing the one or more DDoS event records, a security configuration for the one or more WAF services that indicates one or more parameters of the one or more WAF services to be set based at least in part on the one or more characteristics of the one or more DDoS events;
validate the security configuration in a sandbox environment; and
transmit the security configuration to the one or more WAF services based at least in part on the validation.
